(19) United States
(12) Patent Application Publication
(10) Pub. No.: US 2026/0277200 A1
(43) Pub. Date: Sep. 17, 2026

(54) IDENTIFICATION OF ELECTRICAL SIGNATURES WITH LOCAL MACHINE LEARNING MODELS ON AN IOT-ENABLED MONITOR

(71) Applicant: Volta Insite (US) Inc., Cornelius, NC (US)

(72) Inventors: Karimulla Raja Shaikh, Cupertino, CA (US); Daniel Montbriand, Santa Cruz, CA (US)

(73) Assignee: Volta Insite (US) Inc., Cornelius, NC (US)

(21) Appl. No.: 19/643,944

(22) Filed: Apr. 10, 2026

Related U.S. Application Data
(63) Continuation-in-part of application No. 19/630,591, filed on Mar. 27, 2026.
Application No. 19/630,591 is a continuation-in-part of application No. 19/565,654, filed on Mar. 13, 2026.
(60) Provisional application No. 63/771,714, filed on Mar. 14, 2025.
(60) Provisional application No. 63/779,393, filed on Mar. 28, 2025.
(60) Provisional application No. 63/787,764, filed on Apr. 12, 2025.
(60) Provisional application No. 63/814,170, filed on May 29, 2025.
(60) Provisional application No. 63/824,111, filed on Jun. 15, 2025.
(60) Provisional application No. 63/842,417, filed on Jul. 11, 2025.
(60) Provisional application No. 63/868,054, filed on Aug. 21, 2025.
(60) Provisional application No. 63/875,633, filed on Sep. 4, 2025.
(60) Provisional application No. 63/886,244, filed on Sep. 23, 2025.
(60) Provisional application No. 63/893,080, filed on Oct. 3, 2025.
(60) Provisional application No. 63/908,902, filed on Oct. 31, 2025.
(60) Provisional application No. 63/920,989, filed on Nov. 19, 2025.
(60) Provisional application No. 63/920,997, filed on Nov. 19, 2025.
(60) Provisional application No. 63/927,701, filed on Nov. 30, 2025.
(60) Provisional application No. 63/933,557, filed on Dec. 8, 2025.
(60) Provisional application No. 63/951,992, filed on Dec. 31, 2025.
(60) Provisional application No. 63/969,898, filed on Jan. 28, 2026.
(60) Provisional application No. 63/980,195, filed on Feb. 11, 2026.
(60) Provisional application No. 63/980,279, filed on Feb. 11, 2026.
(60) Provisional application No. 63/991,428, filed on Feb. 26, 2026.
(60) Provisional application No. 63/991,451, filed on Feb. 26, 2026.
(60) Provisional application No. 63/994,200, filed on Mar. 2, 2026.
(60) Provisional application No. 64/004,156, filed on Mar. 12, 2026.

(51) Int. Cl. G05B 19/418; G16Y 40/20

(52) U.S. Cl. CPC G05B 19/41845; G16Y 40/20

(57) ABSTRACT

A machine learning (ML) model is pushed by a cloud server to an industrial IoT electrical monitor (IIEM). The IIEM is coupled to an industrial device within an industrial environment. The IIEM records operational data associated with the industrial device. The recording is based on a sampling frequency. One or more anomalous events associated with the industrial device are identified by the ML model. The identifying is based on the operational data that was recorded and contextual information. The one or more anomalous events that were identified are reported by the IIEM. A user verifies the one or more anomalous events. An action associated with the industrial device is performed. The performing is based on the identifying. The performing is accomplished by an AI agent associated with the industrial device.

### RELATED APPLICATIONS

This application claims the benefit of U.S. provisional patent applications “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IIEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, “Root Cause Analysis Of An Anomalous Event With An Applications Engineer Artificial Intelligence Agent” Ser. No. 64/004,156, filed Mar. 12, 2026, and “In-Place Testing Of Industrial Equipment With Industrial IOT Enabled Monitors And Electrical Injection” Ser. No. 64/019,355, filed Mar. 27, 2026.

This application is also a continuation-in-part of U.S. patent application “Autonomous Identification Of Electrical Signatures With IOT-Enabled Monitors” Ser. No. 19/630,591, filed Mar. 27, 2026, which claims the benefit of U.S. provisional patent applications “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (JJEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, “Auto Channel Mapping For IOT-Enabled Monitors Coupled To Industrial Devices” Ser. No. 63/994,200, filed Mar. 2, 2026, and “Root Cause Analysis Of An Anomalous Event With An Applications Engineer Artificial Intelligence Agent” Ser. No. 64/004,156, filed Mar. 12, 2026.

The U.S. patent application “Autonomous Identification Of Electrical Signatures With IOT-Enabled Monitors” Ser. No. 19/630,591, filed Mar. 27, 2026 is also a continuation-in-part of “Continuous Capture Of Electrical Signatures With IOT Enabled Monitors” Ser. No. 19/565,654, filed Mar. 13, 2026, which claims the benefit of U.S. provisional patent applications “Continuous Capture Of Electrical Signatures With IOT Enabled Monitors” Ser. No. 63/771,714, filed Mar. 14, 2025, “Autonomous Identification Of Electrical Signatures With IOT-Enabled Monitors” Ser. No. 63/779,393, filed Mar. 28, 2025, “Identification Of Electrical Signatures With Local Machine Learning Models On An IOT-Enabled Monitor” Ser. No. 63/787,764, filed Apr. 12, 2025, “Ground Fault Identification With IOT Enabled Monitors” Ser. No. 63/814,170, filed May 29, 2025, “Detection And Response To Frequency Deviations With IOT Enabled Monitors” Ser. No. 63/824,111, filed Jun. 15, 2025, “Frequency Deviation Detection And Response With IOT-Enabled Monitors” Ser. No. 63/842,417, filed Jul. 11, 2025, “Industrial Device Root Cause Analysis With Artificial Intelligence Agents” Ser. No. 63/868,054, filed Aug. 21, 2025, “Root Cause Analysis On Industrial Devices With Artificial Intelligence Agents” Ser. No. 63/875,633, filed Sep. 4, 2025, “Contactor Monitoring And Analysis With IOT-Enabled Monitors” Ser. No. 63/886,244, filed Sep. 23, 2025, “Variable Frequency Drive Isolation With IOT-Enabled Monitors” Ser. No. 63/893,080, filed Oct. 3, 2025, “Reconstruction Of Saturated Electrical Data With Industrial IOT Electrical Monitors” Ser. No. 63/908,902, filed Oct. 31, 2025, “Aggregated Analysis Of Electrical Signatures With Event Filters And Industrial IOT-Enabled Monitors” Ser. No. 63/920,989, filed Nov. 19, 2025, “Self-Regulating Industrial IOT-Enabled Monitors (IEMS) With Event Filters” Ser. No. 63/920,997, filed Nov. 19, 2025, “Monitoring Variable Resolution Electrical Data With Industrial IOT Electrical Monitors” Ser. No. 63/927,701, filed Nov. 30, 2025, “Isolation For Electrical Analysis Of Industrial Equipment With Industrial IOT-Enabled Monitors” Ser. No. 63/933,557, filed Dec. 8, 2025, “Managing Anomalous Events Associated With Industrial Devices With An Applications Engineer Artificial Intelligence Agent” Ser. No. 63/951,992, filed Dec. 31, 2025, “Automatic Initialization Of Industrial IOT-Enabled Monitors” Ser. No. 63/969,898, filed Jan. 28, 2026, “Initializing Industrial IOT-Enabled Monitors With Zero Crossing Time Lags” Ser. No. 63/980,195, filed Feb. 11, 2026, “Residual Back EMF Analysis With Industrial IOT-Enabled Monitors Coupled To Industrial Devices” Ser. No. 63/980,279, filed Feb. 11, 2026, “Recognizing Anomalous Events With Frequency Transformations By IOT-Enabled Monitors” Ser. No. 63/991,428, filed Feb. 26, 2026, “Internal Temperature Tracking Of Industrial Devices With IOT-Enabled Monitors” Ser. No. 63/991,451, filed Feb. 26, 2026, and “Auto Channel Mapping For IOT-Enabled Monitors Coupled To Industrial Devices” Ser. No. 63/994,200, filed Mar. 2, 2026.

Each of the foregoing applications is hereby incorporated by reference in its entirety.

### FIELD OF ART

This application relates generally to equipment monitoring, and more particularly to identification of electrical signatures with local machine learning models on an IoT-enabled monitor.

### BACKGROUND

Industrial equipment plays an important role in enabling infrastructure for essential services such as natural gas and electricity distribution, as well as in the operation of factories that manufacture parts, components, and finished products. The reliability and efficiency of equipment such as compressors, turbines, transformers, and pipelines directly impact the stability of energy grids and fuel supply networks. For example, natural gas distribution relies on a network of high-pressure pipelines and compressor stations to maintain a steady flow of gas to homes, businesses, and power plants. Similarly, electricity distribution depends on substations, transformers, and circuit breakers to ensure a continuous and safe supply of power. Any disruptions in these systems can lead to power outages, fuel shortages, and economic losses.

Beyond energy infrastructure, factories that manufacture industrial equipment, consumer goods, and specialized components are essential to global supply chains. These manufacturing facilities depend on reliable machinery such as CNC (computer numerical control) machines, conveyor systems, and robotic assembly lines to produce goods at scale. The smooth operation of these factories ensures that essential products, ranging from medical devices to automotive parts, remain available to businesses and consumers. Supply chains are highly interconnected, meaning that disruptions in production due to equipment failure, material shortages, or infrastructure breakdowns can create ripple effects across multiple industries.

In addition, data centers are a crucial component of modern infrastructure, supporting various industries, driving technological advancements, and facilitating global commerce. Sectors such as manufacturing, transportation, retail, and financial services rely on data centers to maintain seamless operations and scale efficiently. Businesses leverage data centers for cloud computing, artificial intelligence, and data analytics to enhance performance and inform strategic decision making. E-commerce platforms, financial institutions, and digital entertainment providers depend on secure, high-speed data processing to deliver real-time user experiences. Furthermore, public services, including healthcare systems, emergency responders, and government agencies, utilize data centers to securely store sensitive information and ensure continuous access to critical systems.

Industrial equipment is also fundamental to infrastructure, energy production, and resource management. Power plants, water treatment facilities, and natural gas distribution networks all depend on specialized machinery to deliver essential services to millions of people. Construction and transportation industries also rely on industrial equipment to build roads, bridges, and urban developments that serve modern society. Without the reliable operation of industrial equipment, economies could falter, supply chains could collapse, and daily life as we know it could be severely disrupted. Ensuring the efficiency, maintenance, and innovation of industrial machinery is therefore a critical priority for sustaining global progress.

Industrial equipment is the backbone of modern industry, playing a crucial role in maintaining economic stability and enabling the large-scale production of goods and services. Advanced machinery and automated systems allow businesses to manufacture products with greater speed, precision, and safety, ensuring that supply chains function efficiently. From assembly lines in automotive plants to robotic systems in electronics manufacturing, industrial equipment enhances productivity, minimizes human error, and reduces operational risks. Efficient and reliable industrial equipment is essential for meeting consumer demand in a highly competitive marketplace.

### SUMMARY

Industrial equipment failures can have far-reaching consequences, affecting both production efficiency and supply chain stability. When a critical machine breaks down, entire production lines may be forced to stop, leading to delays, decreased productivity, and disruptions in delivery schedules. In industries such as food processing and chemical manufacturing, equipment failures can result in significant material waste, as perishable goods or sensitive chemical compounds may spoil or become unusable. These setbacks not only increase operational costs but also translate to lost revenue when companies are unable to fulfill customer orders on time.

Beyond immediate production losses, equipment malfunctions can create cascading effects throughout the supply chain. Delays in manufacturing can lead to shortages of essential products, impacting downstream businesses that depend on timely deliveries. In severe cases, prolonged failures can damage a company's reputation, strain business relationships, and even result in contractual penalties. Additionally, certain failures pose safety risks to workers and the surrounding environment. To mitigate these risks, disclosed implementations can enable proactive strategies such as monitoring, predictive analytics, and IoT-based monitoring systems. Thus, disclosed implementations can help detect potential failures before they occur, allowing businesses to maintain operational continuity, reduce downtime, and ensure a steady flow of goods and services.

Disclosed implementations provide an industrial monitoring system that makes use of machine learning models running on edge devices, providing significant advantages for factory environments and other industrial settings. These models can be specifically trained to analyze electrical signatures from industrial equipment, such as conveyor belts and mixers, allowing for real-time anomaly detection. By processing data locally at the edge, disclosed implementations can quickly identify potential issues, such as a sudden drop in electrical current which could indicate a broken conveyor belt or an unexpected surge in power consumption that might suggest a mechanical obstruction in a machine. However, not all anomalies necessarily indicate a failure. For example, some may be expected variations due to operational changes, such as an increase in current draw when a mixer processes a more viscous material. By providing real-time analysis directly at the equipment level, disclosed implementations can reduce downtime, enhance predictive maintenance, and help operators make informed decisions without requiring constant remote oversight.

Disclosed embodiments provide techniques for equipment monitoring. A machine learning (ML) model is pushed by a cloud server to an industrial IoT electrical monitor (IIEM). The IIEM is coupled to an industrial device within an industrial environment. The IIEM records operational data associated with the industrial device. The recording is based on a sampling frequency. One or more anomalous events associated with the industrial device are identified by the ML model, based on the operational data that was recorded and contextual information. The one or more anomalous events that were identified are reported by the IIEM, and the one or more anomalous events are verified by a user.

Disclosed embodiments provide a computer-implemented method for analysis comprising: pushing, by a cloud server, to an industrial IoT electrical monitor (IIEM), a machine learning (ML) model, wherein the IIEM is coupled to an industrial device within an industrial environment; recording, by the IIEM, operational data associated with the industrial device, wherein the recording is based on a sampling frequency; identifying, by the ML model, one or more anomalous events associated with the industrial device, wherein the identifying is based on the operational data that was recorded and contextual information; reporting, by the IIEM, the one or more anomalous events that were identified; and verifying, by a user, the one or more anomalous events.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for autonomous identification of electrical signatures with IoT-enabled monitors.

FIG. 2 is a flow diagram for verifying an anomalous event.

FIG. 3 is an infographic for IoT environments.

FIG. 4 is a block diagram for performing an action based on an anomalous event.

FIG. 5 is a block diagram for refining a local language model for an industrial IoT electrical monitor (IIEM).

FIG. 6 is a block diagram for alternate machine learning models.

FIG. 7 is a block diagram for developing contextual information.

FIG. 8 is an example of a voltage transient.

FIG. 9 is an example of a phase drop.

FIG. 10 is a system diagram for autonomous interpretation of electrical signatures with IoT-enabled monitors.

### DETAILED DESCRIPTION

The global economy is deeply dependent on industrial equipment, which is essential for power generation, refrigeration, maintenance, transportation, and data services, among many other functions. Any disruption, whether due to equipment failure, unplanned maintenance, or intermittent operation, can have a substantial impact on productivity and profitability. However, predicting when a specific machine will fail is a complex challenge. Industrial machines can include numerous components, such as fans, belts, chillers, blowers, gears, and robotic arms, any of which can break down unexpectedly, leading to costly downtime.

Beyond internal mechanical failures, external factors in industrial environments can also impact equipment reliability. Manufacturing floors, food processing plants, and data centers, for example, may experience power fluctuations, including transients that damage sensitive components. Variations in voltage, current, temperature, vibration, and humidity can all contribute to unexpected failures. Given these unpredictable conditions, scheduling maintenance inspections and testing at regular intervals is a common preventive strategy. However, conservative maintenance schedules can lead to unnecessary downtime and lost production, while still failing to prevent malfunctions caused by unforeseen environmental factors. As a result, achieving an optimal balance between maintenance frequency and operational efficiency remains a persistent challenge for industries worldwide.

Disclosed implementations utilize an Industrial Internet of Things (IoT) Electrical Monitor (IIEM) to enable a smart, adaptive approach to monitoring industrial equipment, improving uptime, efficiency, reliability, and cost. Internet of Things (IoT) refers to a network of interconnected devices embedded with sensors, software, and/or communication technologies that collect and exchange data over the Internet. The HEM can enable continuous capture of electrical signatures with IoT-enabled monitors and can upload electrical data to a cloud server based on upload instructions provided by the cloud server. The IIEM can provide real-time alerts for potential failures, unusual power consumption, operational inefficiencies, and so on, enabling intelligent real-time monitoring, automation, and data-driven decision making across various industries. In industrial settings, disclosed implementations can play a crucial role in optimizing operations, improving efficiency, and reducing downtime by providing improved access to, and analysis of, industrial device performance data.

Disclosed implementations that utilize IoT sensors can monitor power supply conditions, power consumption, temperature, vibrations, system efficiency, and/or other parameters. Disclosed implementations can serve to prevent equipment failures by detecting anomalies in power usage or overheating, triggering maintenance alerts and/or automated shutdown of equipment before a failure occurs. Additionally, disclosed implementations can help to optimize energy efficiency by identifying energy-wasting equipment or practices and can provide insights for cost-saving adjustments. Moreover, disclosed implementations can serve to improve safety and compliance by ensuring that industrial devices operate within safe power limits to prevent electrical hazards.

A key advantage of disclosed implementations is the ability to receive feedback from human operators as part of the refining of the anomaly classification process. Disclosed implementations can present detected anomalous events for operator verification, allowing users to confirm whether an event is genuinely an issue or simply an expected deviation. This feedback is then used to refine and retrain the models continuously or periodically, ensuring that the models can become more accurate over time in distinguishing between faults and normal operational variations. By applying machine learning models to edge devices, disclosed implementations can minimize reliance on cloud infrastructure, conserving network bandwidth and addressing data privacy concerns by keeping sensitive operational data on site. Additionally, reducing the need for an internet connection can improve reliability in environments where connectivity may be intermittent. This combination of real-time processing, human-in-the-loop refinement, and localized AI deployment can make disclosed implementations a powerful tool for improving industrial efficiency, reducing maintenance costs, and ensuring uninterrupted operation of critical equipment.

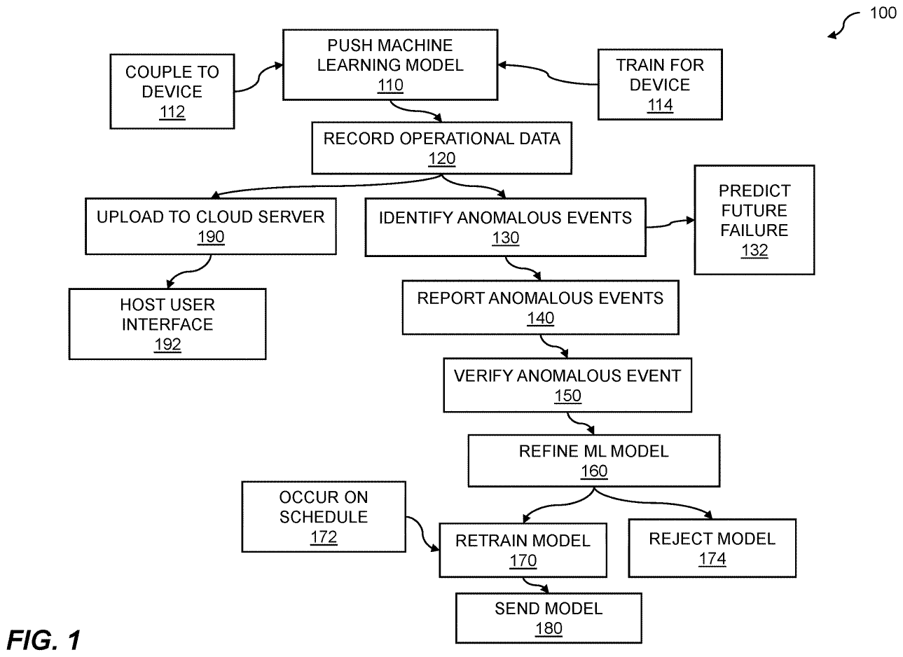

FIG. 1 is a flow diagram for autonomous identification of electrical signatures with IoT-enabled monitors. The flow 100 includes pushing, by a cloud server, to an industrial IoT electrical monitor (IIEM), a machine learning (ML) model 110, wherein the IIEM is coupled to an industrial device within an industrial environment 112. The IEM can include one or more processors, storage, communications, one or more power supplies such as a battery, and so on. The IEM can include a single board computer (SBC) such as a Raspberry Pi® device, Banana Pi® device, BeagleBone® device, NVIDIA Jetson Nano®, a custom-designed computing device, etc. The IIEM can include sensors to measure operational data associated with one or more industrial devices. The operational data can include voltage, current, vibration, humidity, airflow, temperature, and the like. The IIEM can perform local processing on the operational data such as a fast Fourier transform (FFT), short-time Fourier transform (STFT), statistical analysis, data filtering, detection of voltage and/or current spikes, root mean square (RMS) calculations, zero-crossing rate, and/or other relevant calculations. The IIEM can send data to an IoT node which can coordinate sending and receiving data with the cloud server. The HEM can communicate with the IoT node via Bluetooth, cellular communications, wired communications, and so on. The IoT node can be coupled to any number of IIEMs. One or more IIEMs within an environment can be coupled to one or more industrial devices. The one or more IIEMs can send data to the IoT device which can coordinate sending and receiving data with a compute device such as a computer, server, cloud server, etc. The IoT device can include one or more processors, communications interfaces, and so on. The IIEM can communicate with the IoT node via Bluetooth, cellular communications, and so on. In some examples, the IIEM can comprise an IoT node.

The cloud server can include a server in a cloud service such as Amazon Web Services (AWS), a custom managed server, a local server (e.g., on-site server, computer, and so on), etc. The cloud server can include any number of physical servers within a rack, data center, network, and so on. The cloud server can include any type of processor, ASIC, SoC, AI accelerator, etc. Any number of industrial devices can be coupled to an IIEM. The industrial devices that are coupled can include a wide range of equipment such as fans, pumps, compressors, motors, refrigeration units, ovens, server racks, robotic equipment, and so on. The industrial devices can be physically located in an environment. Any environment can be monitored by the IIEM. For example, the equipment can be located in a room within a food processing facility, a rack within a data center, a floor within a manufacturing facility, and so on. Any number of IIEMs can be coupled to any number of industrial devices in any number of environments. In a usage example, a single IIEM can be coupled to a bandsaw and a table saw within a wood shop.

The machine learning model can comprise a large language model (LLM), a small language model (SLM), a neural network, a convolutional neural network, or any other type of machine learning model. The cloud server can train, revise, update, etc. the machine learning model. In disclosed implementations, the cloud server pushes data to an edge device, such as an IIEM, for remote monitoring of industrial equipment. The machine learning model can be associated with a specific industrial device, more than one device, etc. The model may be trained for devices that are similar or identical to each other. In embodiments, the ML model is trained for inferences associated with the industrial device 114. Disclosed implementations can enable running a machine learning model locally on an edge device, such as a Raspberry Pi, providing significant advantages for real-time monitoring of specific equipment, such as a conveyor belt, a mixer, etc. Any number of ML models can be used by any number of IIEMs to monitor different equipment, environments, etc.

In disclosed implementations, the machine learning model can include a small language model (SLM) derived from a larger, more complex large language model (LLM), but specifically fine-tuned to analyze sensor data and perform diagnostic tasks for specific industrial equipment. In disclosed implementations, the SLM focuses on identifying patterns in electrical signals, vibration, temperature, or other environmental variables that are indicative of operational issues such as misalignments, overloading, and/or wear and tear. The operational issues can be specific to the equipment for which the model was trained. By simplifying the larger model and narrowing its focus, the small language model can be optimized to run efficiently on limited computational resources, enabling cost efficient devices such as an IIEM. In embodiments, the ML model is trained for inferences associated with the industrial device. Various SLMs can be trained to identify anomalous events associated with specific equipment coupled to specific IIEMs. In this case, the cloud server can manage a plurality of ML models, such as SLMs, for specific use in one or more IIEMs. In addition, the cloud server can execute a larger model, such as an LLM, which can be used to identify anomalous events within data uploaded by any number of IIEMs.

One or more ML models can be used to detect failures, differences, situations of interest, and so on associated with one or more industrial devices. The ML model can run on the cloud server. The cloud server can have more compute resources than the IIEM, and thus the cloud server can run a larger model such as an LLM. Since the model is larger, the LLM can be trained to analyze operational data for a larger number of industrial devices. In embodiments, the ML model comprises a large language model (LLM), wherein the LLM is trained for inferences associated with a plurality of industrial devices within the industrial environment. Results of a smaller ML model running on one or more IIEMs can be compared to results from a larger ML model running on the cloud server. The model running on the one or more IIEMs can be derived from the model running on the cloud server.

The pushing can occur on a regular schedule, on demand from the IIEM, based on identification of a failure, based on confirmation of a failure, and so on. Accordingly, several protocols and techniques can be utilized for both periodic (scheduled) and asynchronous (unsolicited, interrupt-style) communication. These protocols and techniques allow for efficient data delivery and real-time updates, ensuring that the edge device stays up to date and can respond promptly to any irregularities in the industrial environment. Disclosed implementations can utilize HTTP(S) polling, utilizing RESTful APIs. This approach can be well suited for scheduled updates of machine learning models, as well as scheduled retrieval of information from one or more IIEM devices, such as equipment status, performance metrics, and/or diagnostic information. One or more implementations may utilize MQTT (Message Queuing Telemetry Transport), and/or CoAP (Constrained Application Protocol) instead of, or in addition to, HTTP(S) techniques. Disclosed implementations may further utilize protocols such as WebSockets, AMQP (Advanced Message Queuing Protocol), and/or XMPP (Extensible Messaging and Presence Protocol) in order to support asynchronous messaging, such as sending a high-priority model update, and/or other control and/or status information.

The format of data that is pushed by the cloud server can be in a variety of formats. In disclosed implementations, the format can include a GPTQ (Generalized Quantization for Transformers) format. This format can enable quantizing large language models (LLMs) to lower precision, reducing their memory footprint and computational requirements while maintaining good performance, to enable execution on an edge device, such as an IIEM. The data can include a GGUF (GPTQ Unified Format) file. In disclosed implementations, the GGUF file can be loaded into a machine learning framework such as Ollama, LM Studio, and/or another suitable framework. The data within the GGUF file can include weights, tokenizer data, and/or other metadata associated with a machine learning model. In one or more implementations, the data can include data in the ONNX (Open Neural Network Exchange) format. Other formats, such as JSON (JavaScript Object Notation), YAML, and/or XML (Extensible Markup Language), may be used instead of, or in addition to, the aforementioned formats to provide model data in one or more implementations.

The flow 100 includes recording, by the IIEM, operational data 120 associated with the one or more industrial devices, wherein the recording is based on a sampling frequency. The operational data can include electrical data and/or environmental data. The one or more industrial devices can be operated with power such as AC power, three-phase power, DC power, etc. The IIEM can record electrical data associated with signals, phases, etc. affiliated with such power as is provided. The IIEM can monitor power anywhere along the path of delivery to the industrial device. For example, a utility can provide three-phase power to the industrial environment. The IIEM can monitor each phase of this power input. Before powering the industrial device, the power can run through another device such as a contactor, a variable frequency drive (VFD), etc. The IIEM can monitor power both at the input and output of the contactor, VFD, or any other equipment or node as it is delivered to the industrial device. The IIEM can further monitor power, such as each phase of the three-phase power, at the input of the industrial device. Further, in an industrial environment, it is common for equipment to be manipulated by controllers such as a programmable logic controller (PLC). The IIEM can additionally monitor inputs and outputs of these control devices and compare control states with power delivery. This comprehensive monitoring provides unique insights into power delivery, control signaling, anomalous events, domain knowledge, and so on that can be used to identify, debug, etc. electrical anomalies associated with the industrial devices.

The electrical data can include average current, current spikes, average voltage, voltage spikes, frequency fluctuations, phase loss, phase delays, power interruptions, voltage and/or current transients, voltage waveforms, current waveforms, and so on. The electrical data can include a power factor (PF) that measures how efficiently electrical power is being converted into useful work. A declining power factor can indicate inefficiencies, aging equipment, and/or potential motor failures. The electrical data can include total harmonic distortion (THD). Harmonic distortions in voltage or current can indicate issues such as improper loads or electrical interference. The electrical data can include voltage imbalance in a three-phase system, which can lead to overheating, inefficiencies, and/or motor damage. The electrical data can include current imbalance in a three-phase system, which can indicate unbalanced loads and/or faulty components. The electrical data can include neutral current monitoring, which can identify unexpected currents on a neutral wire. These currents can indicate grounding issues or unbalanced phase loads. Disclosed implementations may record other electrical data instead of, or in addition to, the aforementioned electrical data. Environmental data, such as vibration data, humidity data, temperature data, and so on, can be recorded. The recording can occur at a sampling frequency, which can be different from the uploading frequency. The sampling frequency can occur at a fast enough rate to monitor changes in voltage, current, etc. For example, the sampling frequency can be 20 kHz, 40 kHz, 1 MHz, or another appropriate sampling rate. The recording can include environmental data. In embodiments, the environmental data includes temperature data. In some embodiments, the environmental data includes vibration data. In other embodiments, the environmental data includes humidity data.

The flow 100 includes identifying, by the ML model, one or more anomalous events 130 associated with the industrial device, wherein the identifying is based on the operational data that was recorded and contextual information. The language model running on the IIEM can perform any number of inferences on data obtained from one or more industrial devices to identify any number of anomalous events. An anomalous event can refer to a failure, a difference from normal operation, and so on in a piece of equipment. Anomalous events can be reported to a user, a floor manager, maintenance personnel, etc. to investigate whether a part failed or experienced a partial failure, to protect against a future failure, to investigate a non-normal operation, etc. The anomalous event can be associated with a signature within the operational data that was collected by the IIEM. The signature can include electrical data such as voltage and current behavior; environmental data such as vibration, humidity, airflow, or temperature data; data locally analyzed by the IIEM such as an FFT (fast Fourier transform); and so on. The electrical signature can be correlated to an anomalous event by the LLM and applied to one or more pieces of equipment.

Examples of anomalous events can occur in situations such as motor aging and/or increased mechanical resistance that may correlate to unusually high and/or prolonged current spikes. An anomalous event can include equipment overheating or loss of efficiency which may be indicated by harmonic distortions above a threshold. An anomalous event can include a different, heavier, material being mixed within a mixer which may be indicated by a change in current load. An anomalous event can include an unplanned equipment shutdown which can be indicated by an unexpected load drop or decrease in power consumption. An anomalous event can include improper grounding issues which may be indicated by a rise in neutral current. Similarly, a broken drive belt on a motor may be indicated by a sudden, sharp increase in current followed by a drop in load in the electrical data uploaded by the HEM. When the belt breaks, the motor can spin freely without the load, drawing less power afterward. In another example, a worn-out bearing in a fan or pump causing mechanical resistance may be indicated by a fluctuating voltage combined with a prolonged high current draw. Another example anomalous event can include a motor speed controller failure which may be indicated by repeated oscillations in current draw, where the regulator fails to stabilize the RPMs of the motor. An anomalous event can include coil degradation and/or insulation breakdown in a motor which may be indicated by a slow, consistent rise in current draw without a corresponding load increase. A further example anomalous event can include loose wiring and/or failing relays which may be indicated by intermittent current drops.

Disclosed implementations can continuously compare data uploaded by any number of IIEMs against contextual information to detect an anomalous event. In embodiments, the identifying includes predicting, by the ML model, a future failure 132 of the industrial device. The detection can identify a failure, an intermittent failure, and so on. Disclosed implementations can predict a likely cause and alert maintenance staff with a likely explanation, which can be much more helpful than a simple error code for quickly resolving the issue, reducing equipment downtime, and improving overall efficiency of an industrial facility. Identifying one or more anomalous events can be key to maintaining uptime of industrial equipment. For example, to protect and debug equipment, a user can be notified to react to an anomalous event by briefly taking a machine offline, examining sensitive parts for failure or signs of fatigue, scheduling a maintenance interval, increasing the IEM uploading frequency to look for additional failure signatures, and so on. The predicting can be based on historical data corresponding to previous failures of similar industrial devices.

Embodiments include uploading data, by the IIEM, to the cloud server 190, wherein the uploading is based on an upload frequency. The uploading can include model information, operational data from one or more industrial machines, and/or other data. The other data can include data from external data sources which can significantly enhance the overall monitoring and predictive capabilities of disclosed implementations. Disclosed implementations may monitor meteorological data to track severe weather events such as hurricanes, tornadoes, or heavy rainfall, which could potentially impact operations by causing equipment damage, power outages, or hazardous conditions. By integrating this data into the monitoring system, operators can receive real-time alerts that allow them to take preventive actions, such as shutting down equipment, reinforcing vulnerable systems, or scheduling maintenance ahead of time. Similarly, seismic data can be monitored and used to detect earthquakes or ground shifts that may affect the stability of machinery or infrastructure. Real-time earthquake alerts can help ensure that operators are aware of potential risks, enabling them to quickly halt operations to prevent further damage or safety incidents. Thus, disclosed implementations can provide a more comprehensive view of the factors influencing equipment performance, enabling more proactive management and minimizing the risk of unforeseen downtime. By integrating external data sources, such as weather and seismic monitoring, into the overall monitoring framework, disclosed implementations can improve operational resilience and enhance safety in the operation of industrial devices.

Some embodiments include hosting, by the cloud server, a user interface 192. Disclosed implementations can include integration of a cloud-hosted user interface (UI) that can provide significant advantages in enhancing the monitoring and refinement of machine learning models used for industrial equipment. One of the primary benefits is the ability to collect human feedback in real time, enabling continuous model improvement. When a machine learning model detects an anomalous event, such as a malfunction or a change in the equipment's performance, an operator can validate whether the model's assessment is correct. If the model identifies an issue like a broken belt but the operator determines it was caused by a different factor, this feedback can be used to refine the model's ability to accurately identify future anomalies. This can enable a dynamic, self-improving system where the machine learning model adapts to new conditions and operating environments, ultimately improving the accuracy of anomaly detection and reducing false positives or negatives. In embodiments, the user interface includes, for the industrial device, the operational data that was uploaded. In embodiments, the user interface includes a status of the industrial device, wherein the status is based on the recording. In some implementations, the user interface can be hosted locally, at the industrial environment, instead of being cloud hosted.

In disclosed implementations, the user interface (UI) includes various functions to streamline the user feedback process. Disclosed implementations can provide a dashboard displaying real-time data from the IIEMs, highlighting any anomalous events detected by the respective machine learning models. Annotations or feedback options can be rendered and presented directly next to each event, allowing operators to quickly mark whether the detection was accurate. In disclosed implementations, the UI may further provide a history of previous feedback and model adjustments, helping operators understand how the system has evolved over time. Additionally, disclosed implementations can provide an interface for manually inputting contextual information, such as changes in operational conditions or external factors (e.g., weather or seismic events) that may influence equipment performance. By facilitating continuous operator engagement with the system, disclosed implementations can serve to improve the performance of the machine learning model, thereby enhancing overall system reliability and operational efficiency. In disclosed implementations, the user interface can be a web-based user interface.

The flow 100 includes reporting, by the IIEM, the one or more anomalous events that were identified 140. The one or more anomalous events can be based on the operational data that was recorded. The anomalous events, such as those described in detail above, can be sent to a user, system administrator, shop manager, maintenance technician, and so on. The reporting can be based on an email, text, alert, phone call, etc. The reporting can include a confidence level associated with the anomalous event. That is, since many different equipment situations and/or failures can occur under many different electrical and environmental conditions, it may not be possible to directly correlate the anomalous event with a known failure. The language model can generate a probability based on the contextual information to guide the urgency with which the event should be handled. In embodiments, the identifying and the reporting do not require communication to the cloud server. Because the ML model can run at the edge (e.g., on the IIEM), the identifying and reporting can be accomplished locally. This can be advantageous for environments which experience an internet outage as operations can continue to be monitored without an internet connection. Local ML models can also provide additional security sensitive data that does not need to be sent across the Internet.

The flow 100 includes verifying, by a user, the one or more anomalous events 150. The verifying can include receiving confirmation from maintenance personnel, engineers, and/or other qualified stakeholders that the reported failure mode is correct. Reporting a failure mode as correct can reinforce the model training. Reporting a failure mode as incorrect can enable a feedback loop that allows for ongoing retraining of the language model. As an example, a slight voltage dip might not always be indicative of loose wiring or a relay failure. By receiving the feedback from personnel, the language model can learn distinctions, such as what degree of voltage fluctuation determines an actionable event.

As described above, the cloud server can host any number of ML models to be pushed to one or more IIEMs. The ML models, such as SLMs, can be trained for specific environments, equipment, conditions, etc. In a usage example, the cloud server can push a unique SLM to each IIEM within an environment. Each IIEM can record data, identify an anomalous event based on specific training of the model, and report the anomalous events. A user can then verify the events. Each of the models can be refined by the IIEM on which it runs or can be retrained by the cloud server. In embodiments, the pushing, the recording, the identifying, the reporting, and the verifying include a second ML model and a second IIEM coupled to a second industrial device. In embodiments, the second ML model is trained for inferences associated with the second industrial device,

Embodiments include refining the ML model 160, by the IIEM, wherein the refining is based on the verifying. The language model can comprise a large language model (LLM). An LLM can have millions or even billions of parameters, requiring many processors, AI accelerators, etc. to retrain the model. Thus, the retraining process can take considerable time and energy. Because of compute power limitations, it may not be feasible to fully retrain the LLM to take advantage of new data reflected in updated contextual information. In these cases, the LLM can be refined. In embodiments, the refining is based on parameter-efficient tuning. The parameter-efficient tuning can include adapter tuning, prefix tuning, Low-Rank adaptation (LoRA), and/or other suitable techniques. In other embodiments, the refining is based on retrieval-augmented generation (RAG). In disclosed implementations, the RAG can provide a framework that combines the strengths of LLMs with external knowledge retrieval systems to enhance their performance on tasks that make use of up-to-date and/or domain-specific information. In disclosed implementations, the RAG can be configured to dynamically retrieve relevant information from external sources, such as databases, document repositories, and/or other sources, during inference. The retrieved data can be fed into the language model, which uses them as context to generate a response or perform a task. This augmentation allows the model to produce outputs that are both accurate and grounded in the retrieved knowledge, which can include one or more signatures and associated historical events. The refining can include anomaly clustering. As an example, if an unknown anomaly keeps recurring, the model can group similar patterns and suggest new failure modes if the unknown anomaly has some resemblance to prior failure events. The refining can include transfer learning. As an example, if a language model is well trained for analyzing motor data, that language model can be retrained on similar data for different types of equipment, such as pumps and/or fans, without starting training for those other industrial devices with a completely untrained language model. In embodiments, the language model comprises a small language model (SLM). Some implementations can include training the SLM, where the training is based on the contextual information that was updated. One or more implementations may utilize knowledge distillation to train a small language model (SLM) from an LLM, where the SLM can achieve acceptable performance while being efficient enough to operate with considerably less compute power than the LLM. In embodiments, the ML model comprises a small language model (SLM). Any ML model can be used. Other embodiments include retraining the SLM. The retraining of the SLM can be performed by the cloud server. The retrained SLM can be pushed back down to an hEM for execution, inferencing, etc.

In disclosed implementations, the SLM is executed on an edge device, such as an IIEM. This enables multiple benefits, particularly in reducing reliance on internet connections, conserving network bandwidth, and maintaining data privacy. By running machine learning models locally on devices such as an IEM and/or other edge hardware, much of the processing and anomaly detection can occur directly on site, without the need to continuously transmit large volumes of data to a central cloud server. This approach reduces the strain on network bandwidth, especially in environments with limited or unstable internet connectivity, and allows for faster decision making since processing happens locally in real time. Furthermore, sensitive data, such as machine performance metrics or operational details, can be kept on the HEM, ensuring privacy and compliance with data protection regulations, rather than being sent to external servers. This setup helps minimize potential security risks, such as unauthorized data access or breaches, while still allowing the system to function efficiently. Overall, leveraging small language models on edge devices can make the system more autonomous, cost effective, and secure, providing operational advantages without sacrificing performance. In disclosed implementations, the refining can include fine-tuning, transfer learning, hyperparameter tuning, and/or other suitable techniques.

Embodiments include rejecting, by the cloud server, the ML model 174 that was refined. The rejection can be based on determined model regret. In disclosed implementations, if the model regret is determined to exceed a defined threshold, indicating that the model consistently selects suboptimal predictions relative to its potential performance, then the cloud server can reject the model and initiate retraining. Such regret-based evaluation can involve analyzing historical inference outcomes compared to optimal or ground-truth actions over time. In some implementations, a Monte Carlo Tree Search (MCTS) module can be used as part of the regret detection mechanism. MCTS can simulate multiple decision paths based on the model's output and compare their cumulative reward (or accuracy) against expected benchmarks. When the observed model regret becomes super-exponential or disproportionately skewed toward non-optimal branches, this may be interpreted as a degradation in model performance or learning drift. Upon detecting such conditions, the cloud server can flag the model as unfit for deployment, and a retraining sequence can be triggered using updated training datasets, additional labeled data, or alternative hyperparameter tuning strategies. This dynamic model validation and retraining loop can improve the robustness and reliability of machine learning models in mission-critical applications.

Embodiments include retraining the ML model 170, by the cloud server. The model retraining can include using new or augmented training datasets to address data drift and/or other factors. Deciding when to retrain a machine learning model for industrial device monitoring can involve a balance between maintaining model accuracy and avoiding unnecessary computational overhead. An indicator that retraining is necessary can be a decrease in the model's predictive accuracy over time. If the system frequently misclassifies anomalous electrical signatures, such as confusing a routine increase in motor load with a mechanical failure, this can suggest that the model is no longer aligned with real-world conditions. Disclosed implementations enable continuous human feedback through a cloud-hosted interface that can help identify such trends, as operators can flag incorrect assessments. If the rate of flagged misclassifications reaches a certain threshold, it can be a signal that retraining is required to improve accuracy and adaptability. In embodiments, the retraining is based on the refining.

Another consideration for retraining is when operational or environmental conditions change significantly. For example, if a factory upgrades equipment, starts using different materials, or experiences seasonal variations in power supply, these changes can introduce new electrical signature patterns that the existing model may not be trained to recognize. Additionally, if new types of anomalous events occur that were not part of the original training dataset, such as unexpected component failures or external disruptions like power fluctuations due to severe weather, retraining the model with updated data can ensure that it remains relevant. In embodiments, the retraining is in response to the one or more anomalous events that were identified. In embodiments, the retraining occurs on a schedule 172. To optimize performance, retraining can be scheduled periodically, triggered dynamically based on error rates, or occur in real time using continuous learning techniques. In embodiments, the retraining occurs on a schedule.

The flow 100 further includes sending the model to an HEM 180. The model that is sent can include a distilled small language model. A distilled small language model can refer to a compact version of a larger language model that has undergone a process called knowledge distillation to retain essential capabilities while reducing size and computational complexity. In machine learning, knowledge distillation is a technique where a smaller model (the “student”) is trained to mimic the behavior of a larger, more powerful model (the “teacher”). The student model learns from the predictions of the teacher, rather than just the raw training data, allowing the student model to approximate the teacher model performance with significantly fewer parameters. In the context of industrial device monitoring on edge devices such as an IIEM, a distilled small language model can be derived from a larger general-purpose model, but specialized for a specific task, such as analyzing electrical signatures to detect equipment anomalies on a particular piece of equipment. The smaller model can maintain key functionalities while being optimized to run efficiently on resource-constrained hardware like an IIEM, which can be implemented by a Raspberry Pi with an AI accelerator, and/or other suitable hardware. This approach can reduce latency, conserve network bandwidth (by enabling local inference rather than relying on cloud-based models), and enhance data privacy by keeping sensitive industrial data on site rather than transmitting it over the Internet. Embodiments can include sending, to the HEM, the ML model that was retrained.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

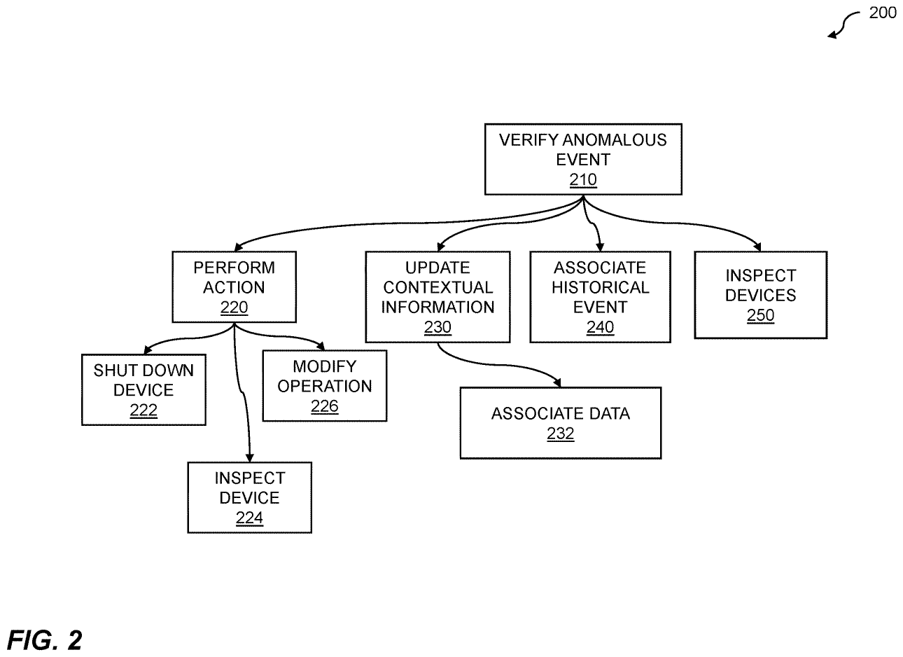

FIG. 2 is a flow diagram for verifying an anomalous event. The flow 200 includes verifying an anomalous event 210. The verification of the anomalous event can include confirming the anomalous event as having actually occurred. This verification process may involve the machine operator and/or other personnel assessing real-world conditions to determine if the detected anomaly corresponds to an actual issue. For example, if the system predicts a broken belt due to a sudden drop in motor current, the operator can visually inspect the machine and confirm the belt failure via the user interface. Conversely, if the model detects an increase in current and incorrectly attributes it to motor failure, the operator can review the operating conditions, such as the load on the conveyor, and provide feedback that the higher current draw was due to the use of heavier materials rather than equipment malfunction.

By continuously incorporating human feedback, disclosed implementations can refine predictive capabilities over time, reducing false positives and improving anomaly detection accuracy. The user interface can further provide options for tagging, categorizing, or annotating anomalies, allowing operators to specify whether the event was expected, a genuine fault, and/or an environmental factor. This information can be logged for future reference, contributing to periodic retraining of the model. Additionally, confidence scores may be displayed, helping operators prioritize responses based on the likelihood of actual failure. Over time, this feedback loop can enable adaptive learning, ensuring that the model remains aligned with evolving industrial processes and operating conditions.

The flow 200 includes performing an action 220. Embodiments include performing an action associated with the industrial device, wherein the performing is based on the identifying. In embodiments, the action includes shutting down the industrial device 222. Shutting down the device can reduce the risk of damage and/or unsafe operating conditions. For example, if the system of disclosed implementations detects a severe mechanical failure, such as a seized motor and/or overheating component, immediate shutdown can prevent further damage and avoid costly repairs. In cases where safety hazards are present, such as excessive vibrations in a high-speed industrial machine, an automatic shutdown can protect workers from potential injury. Additionally, controlled shutdown procedures can ensure that auxiliary systems, such as cooling mechanisms or backup power supplies, are properly engaged to prevent secondary failures.

In embodiments, the action comprises inspecting the industrial device 224. In disclosed implementations, some or all of the inspections may be computerized, such as performing a BIST (built-in self-test) operation. BIST operations can include running diagnostic routines to assess sensor accuracy, checking for electrical inconsistencies, and/or verifying system firmware integrity. In automated manufacturing settings, robotic inspection systems equipped with thermal imaging and/or vibration analysis tools can provide additional insights into the machine's health. If the self-test detects anomalies but does not confirm a failure, an operator can be prompted to conduct a manual inspection to further diagnose the issue before taking corrective action.

Embodiments include modifying one or more operational parameters 226 of the industrial device. The modify operation can include reducing the speed of a machine, reducing power consumption of a machine, and so on. The modify operation can allow the machine to run at a reduced level while maintenance staff inspects the machine. For example, if an electrical current spike is detected in a conveyor motor, the system may temporarily reduce the belt speed to prevent excessive wear while a technician evaluates the issue. Similarly, in a mixer with increased resistance due to a thicker-than-usual material, reducing the motor speed can prevent overheating or mechanical stress while ensuring that production continues. In some cases, dynamic adjustments can be made autonomously, such as gradually ramping down power instead of an abrupt stop, to avoid sudden disruptions to workflow.

The flow 200 includes updating contextual information 230. In embodiments, the verifying includes updating the contextual information with the one or more anomalous events that were verified. Thus, in embodiments, the contextual information includes a plurality of verified historical events. The flow 200 includes associating data 232. In embodiments, the updating includes associating the one or more anomalous events with the operational data that was recorded. In disclosed implementations, the contextual information can include tuples of associated information, such as electrical signatures and corresponding anomalous events such as belts breaking, bearings seizing, and so on. These tuples can help refine the accuracy of the model by establishing clear relationships between specific electrical patterns and real-world mechanical failures. Over time, as more events are recorded and confirmed by human operators, the system can better differentiate between normal operational variations and actual faults, reducing false positives.

Embodiments include associating each verified historical event 240 within the plurality of verified historical events with one or more event signatures. The historical event can include events obtained from log files from one or more industrial devices. By comparing new anomalous events to past occurrences, disclosed implementations can identify recurring issues, predict potential failures, and recommend preemptive maintenance. For example, if a motor has experienced similar voltage fluctuations before seizing in the past, the system can alert maintenance staff ahead of time when those same fluctuations appear again.

In embodiments, the verifying includes inspecting 250 the one or more industrial devices. The devices can include industrial devices that experienced an anomalous event, a potential anomalous event, etc. In disclosed implementations, the inspecting can include remote inspection and/or automatically putting an industrial device into a diagnostics mode. For example, if a conveyor belt motor exhibits an unusual current drop, the system may trigger a built-in self-test (BIST) to check for mechanical resistance or misalignment. Remote monitoring tools such as thermal imaging cameras or vibration sensors could also be leveraged to assess the machine's condition without requiring immediate on-site intervention. In this way, the anomalous events are confirmed, contributing to a continuous learning process for the models.

Disclosed implementations can further include identifying a “repeat offender” device and issuing a recommendation for its replacement. A repeat offender device is an industrial asset that experiences significantly higher failure rates compared to similar devices operating under similar conditions. By analyzing historical failure data, maintenance records, and anomalous event logs, disclosed implementations can flag devices that frequently require intervention. For example, if a specific conveyor belt motor consistently exhibits current dips and voltage fluctuations, while identical motors in the same factory remain stable, disclosed implementations can identify this discrepancy. The device can be tracked using unique identifiers such as a serial number, MAC address, and/or asset tag, ensuring that maintenance teams can pinpoint the problematic equipment. Once a device is flagged as a repeat offender, disclosed implementations can issue a proactive recommendation for replacement, reducing downtime and preventing costly production delays. Additionally, disclosed implementations can provide supporting data, such as maintenance frequency, failure patterns, and cost-benefit analyses, to justify the replacement decision. This data-driven approach can help businesses optimize their equipment lifecycle management, ensuring operational efficiency and cost savings.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

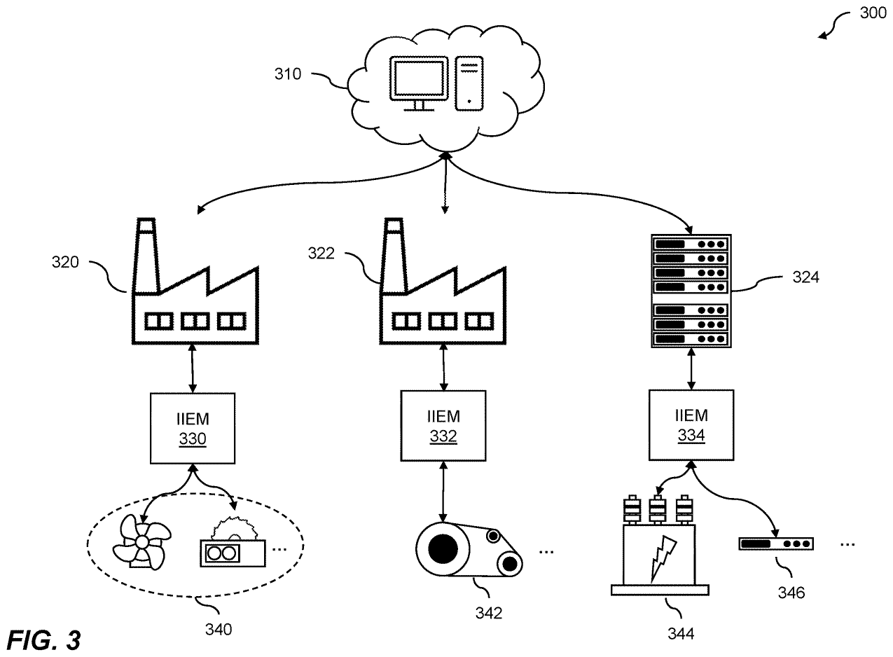

FIG. 3 is an infographic for IoT environments. An IoT environment can enable techniques for equipment monitoring. An industrial IoT electrical monitor (IIEM) can be accessed. The IIEM can be coupled to one or more industrial devices within one or more environments. The HEM can detect and record any operating condition of electrical equipment such as voltage, current, humidity, temperature, vibration, and so on. The IIEM can receive one or more uploading instructions from a cloud server. The one or more uploading instructions can detail how and when the HEM should upload electrical data to a cloud server. The HEM can use different instructions for each coupled piece of electrical equipment. Electrical data associated with one or more industrial devices is recorded by the IIEM. The IIEM can determine whether the electrical data that was recorded represents an anomalous event which is related to the one or more industrial devices. The determining can be based on the one or more uploading instructions. The IEM can upload the electrical data to a cloud server, based on the determining. The IIEM can analyze, summarize, etc. the electrical data prior to the uploading.

The Internet of Things (IoT) can refer to a network of interconnected devices that can exchange information over a network such as the Internet, a mobile network such as 5G or long-term evolution (LTE), a private network, short-range communication networks such as Bluetooth, and so on. The devices can include any function for which communication is desired. For example, IoT devices can be used in securing a home with devices such as security cameras, smart thermostats, smart door locks, kitchen appliances, smoke detectors, and so on. These devices can communicate with other devices, systems, networks, etc. to report a status, an error, an alert, and so on. Software such as a web application or mobile application can accumulate data from IoT devices and show status, connectivity, battery power, live information, warnings, etc. associated with the devices. Many other applications of IoT devices are possible, such as fitness trackers, smart cars, smart lighting, smart appliances such as ovens and refrigerators, smart plugs and outlets, and so on. The Industrial IoT (IIoT) is an extension of IoT for industrial devices to monitor function, environment, behavior, etc. of machines within industrial environments such as data centers, manufacturing facilities, power plants, wastewater treatment facilities, and many others. The devices can comprise sensors, instruments, machines, etc. that can exchange real-time data about the conditions of one or more machines within the environment, report problems, take actions (such as shutting off a machine), and so on. Such devices can include temperature sensors, pressure sensors, vibration sensors, flow sensors, actuators, monitors, programmable logic controllers (PLCs), and many more.

In disclosed implementations, the IIEM can include a Raspberry Pi equipped with an AI accelerator to enable the model to process data in real time directly on the HEM device, without the need for constant communication with a cloud server. This approach can reduce latency, enable faster response times for anomaly detection, and decrease the dependency on network connectivity. Moreover, by processing the data locally, sensitive information remains within the local network, addressing potential security and privacy concerns. This approach allows disclosed implementations to continuously monitor equipment, detect irregularities, and generate alerts or insights, making it an ideal solution for industries where uptime and predictive maintenance are critical.

One significant benefit of using off-the-shelf components such as a Raspberry Pi for the IEM is the flexibility and cost effectiveness it offers to both service providers and end customers. In these implementations, customers can purchase their own Raspberry Pi or similar edge device as needed, allowing them to scale their monitoring infrastructure without relying on the service provider to supply expensive, specialized hardware. Once the device is purchased, the customer can load the monitoring firmware onto the device, which can be enabled via pre-configured images and/or user-friendly setup processes. The IIEM can then automatically register with the cloud server, seamlessly integrating with the larger monitoring ecosystem.

In disclosed implementations, the IIEM can comprise an IoT node which can interconnect devices, sensors, and servers to collect and exchange information over the Internet. The IIEM can include one or more communication transceivers. The communication transceivers can be based on BLE (Bluetooth Low Energy); Wi-Fi; cellular communication protocols such as 4G, 5G, and LTE-M; and/or other suitable communication protocols. The transceivers can enable high-speed data transfer to cloud servers and/or local networks. Other communication transceivers can include LoRa (Long Range) and/or Zigbee communication receivers. In some cases, one or more IoT nodes may include an ethernet port, serial port, and/or other port that supports wired communication, instead of, or in addition to, the communication transceivers.

In some implementations, the HEM can be distinct from an IoT node. In those cases, one or more IIEMs within an environment can be coupled to one or more industrial devices. The one or more IIEMs can send data to the IoT device which can coordinate sending and receiving data with a compute device such as a computer, server, cloud server, etc. The IoT device can include one or more processors, communications interfaces, and so on. The IIEM can communicate with the IoT node via Bluetooth, cellular communications, and so on. In some cases, one or more IoT nodes may include an ethernet port, serial port, and/or other port that supports wired communication.

The IIEM can include a power source. The power source can include a battery, such as a rechargeable battery. In disclosed implementations, the battery can include a lithium-ion battery, lithium-ion polymer battery, and/or other suitable type of battery. In some cases, one or more IIEMs may include PoE (power over ethernet) to enable providing both power and network connectivity via a single cable. Some IIEMs may include energy harvesting features, such as solar cells, vibration-based energy generation, and/or other renewable energy sources that can enable remote, self-sustaining IoT monitoring.

The IEM can include one or more processors. The processors can include an ARM®-based processor, a MIPS®-based processor, a custom processor, application specific integrated circuits (ASICs), systems-on-chip (SoCs), one or more embedded controllers, and/or another suitable processor type. The processors can serve to read sensor data, process interrupts, perform communication tasks, and/or execute other processes to accomplish IoT-based industrial device monitoring. The processor(s) can interface with an input/output (I/O) module. The I/O module can include analog inputs to enable reading signals from analog sensors such as temperature probes, current meters, voltage meters, and so on. The I/O module can include one or more analog-to-digital converters (ADCs) to convert analog signal levels into digital values. The I/O module can include digital inputs and outputs, such as General Purpose I/O (GPIO), in order to interface with other types of sensors such as tilt sensors, gyroscopes, accelerometers, and/or other types of sensors that provide digital outputs. Additionally, the I/O module can interface with an output device, such as an LED, buzzer, or other suitable output device. The I/O module can interface to a wide variety of sensors. The sensors can include temperature and humidity sensors to monitor environmental conditions. The sensors can include vibration sensors, which can be used to detect mechanical wear and/or anomalies in industrial equipment. The sensors can include current sensors and voltage sensors, which can measure power consumption and/or detect electrical issues. Other types of sensors can be used in disclosed implementations.

The IIEM can include computer storage, such as flash memory, for storing firmware images, configuration settings, sensor logs, waveforms, and so on. Additionally, some IIEMs can include an external storage interface, such as a microSD card slot, to enable local retrieval of collected data and/or logs. The computer storage can also include random-access memory (RAM) for supporting program execution and in some cases, analysis and/or processing of collected data.

The IIEM can be coupled to the one or more industrial devices via a network connection. The network connection can be a wireless connection, such as via BLE, Wi-Fi, or some other suitable connection. The network connection can be a wired connection, such as an ethernet connection, serial connection (e.g., RS-232, RS-485, or the like), and/or other type of wired connection. The coupling can include access, by the IIEM, to internal nodes of the industrial equipment to monitor internal conditions. The coupling can include access to current and/or voltage entering or exiting the industrial device. The one or more industrial devices can include robotic arms, CNC machines, 3D printers, welding machines, injection molding machines, conveyor belts, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, water treatment systems, data center computer servers, network switches, routers, and/or other types of industrial devices. Any type of equipment that requires electricity can be monitored by the HEM.

A single IIEM can be coupled to a single device or multiple devices, providing efficient IoT monitoring. The equipment can be physically located in an environment. Any environment can be monitored by the IIEM. For example, the equipment can be located in a room within a food processing facility, a rack within a data center, a floor within a manufacturing facility, and so on. Any number of IIEMs can be coupled to any number of industrial devices in any number of environments. In a usage example, a single IIEM can be coupled to a bandsaw and a table saw within a wood shop.

The infographic 300 includes a cloud server 310. In disclosed implementations, the cloud server 310 can be implemented as a bare metal server, one or more containerized instances, and/or one or more virtual machines. The cloud server can include a server in a cloud service such as Amazon Web Services (AWS), a custom-managed server, a local server (e.g., on-site server, computer, and so on), etc. The cloud server can include any number of physical servers within a rack, data center, network, and so on. The cloud server can include any type of processor, ASIC, SoC, AI accelerator, etc. Load balancing and/or orchestration can be used to enable scaling of cloud server capabilities as the number of industrial devices being monitored increases. The cloud server can communicate with one or more IIEM devices located in various environments, such as facilities and/or locations which house equipment. The cloud server can communicate with the one or more IIEM devices via the Internet, cellular networks, satellite networks, and/or other suitable communication techniques. The ITEM can comprise an IoT node.

As shown in infographic 300, a first HEM 330 is installed within a first environment 320, a second HEM 332 is installed within a second environment 322, and a third ITEM 334 is installed within a third environment 324. The first and second environments are shown as manufacturing facilities, and the third environment is shown as a data center. In practice, any environment can be monitored by the IIEM. For example, the equipment can be located in a room within a food processing facility, a rack within a data center, a floor within a manufacturing facility, outdoors, and so on. Any number of IIEMs can be coupled to any number of industrial devices in any number of environments. In a usage example, a single IIEM can be coupled to a bandsaw and a table saw within a wood shop. In the infographic 300, IIEM 330 monitors two industrial devices 340, a fan and a table saw, within environment 320. IIEM 332 monitors a single belt drive 342 within environment 322. ITEM 334 monitors a generator 344 and computing equipment 346 within environment 324, a data center.

Environment 320, environment 322, and environment 324 can be located in different geographical regions, or similar regions. The industrial devices can include elevators, centrifuges, saws, drills, conveyor belts, CNC machines, 3D printers, welding machines, injection molding machines, robotic arms, packaging equipment, sorting machines, uninterruptible power supplies, generators, power transformers, industrial circuit breakers, power distribution units, industrial HVAC systems, furnaces, boilers, refrigeration units, dehumidifiers and humidifiers, pumps, compressors, mixing tanks, water treatment systems, data center computer servers, network switches, load balancers, uninterruptible power supplies, routers, and/or other types of industrial devices. The IIEMs shown in infographic 300 can capture data from the industrial equipment, and can analyze, summarize, and/or send the data to the cloud server. The IIEMs can be instrumental in recognizing and preventing industrial equipment failures. In embodiments, the pushing, the recording, the identifying, the reporting, and the verifying include a second ML model and a second HEM coupled to a second industrial device. In embodiments, the second ML model is trained for inferences associated with the second industrial device. Embodiments can include uploading data, by the IIEM, to the cloud server, wherein the uploading is based on an upload frequency.

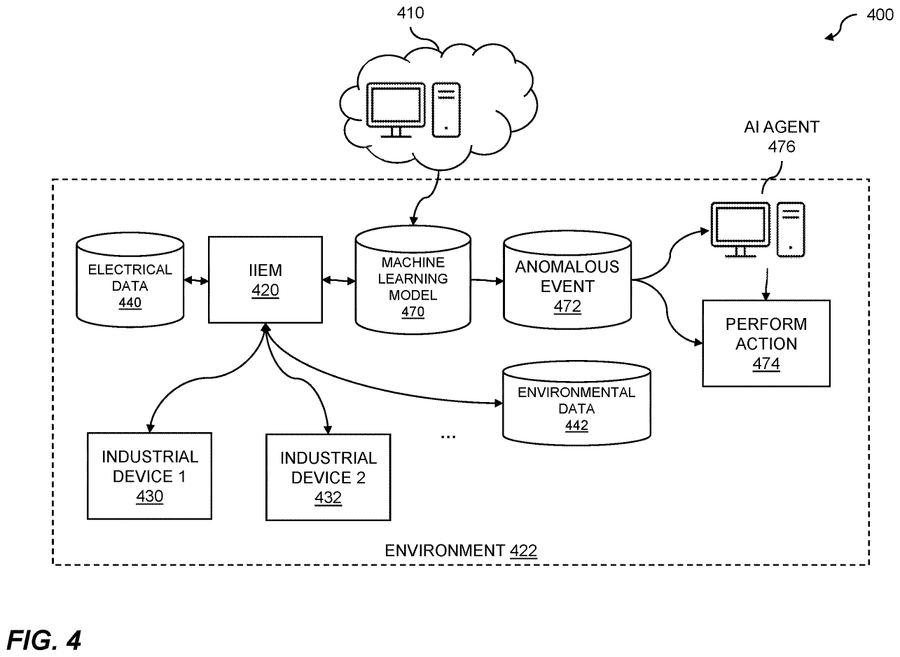

FIG. 4 is a block diagram for performing an action based on an anomalous event. The block diagram 400 includes a cloud server 410. Similar to cloud server 310 described previously, cloud server 410 can be implemented as a bare metal server, one or more containerized instances, and/or one or more virtual machines. The cloud server can include a server in a cloud service such as Amazon Web Services (AWS), a custom managed server, a local server (e.g., on-site server, computer, and so on), etc. The cloud server can include any number of physical servers within a rack, data center, network, and so on. The cloud server can include any type of processor, ASIC, SoC, AI accelerator, etc. Load balancing and/or orchestration can be used to enable scaling of cloud server capabilities as the number of industrial devices being monitored increases.

The cloud server 410 can communicate with one or more IIEM devices located at various facilities and/or locations. The cloud server can communicate with the one or more IIEM devices via the Internet, cellular networks, satellite networks, and/or other suitable communication techniques. The cloud server can send one or more sets of uploading instructions to the one or more IIEMs to instruct IIEMs on how often data should be reported, what types of data should be reported, or if local analysis should be performed; to scan for one or more situations of interest; etc. As shown in block diagram 400, the cloud server is configured to communicate with an ITEM 420 within an environment 422. While one environment is shown in block diagram 400, in practice, there can be more than one environment. Different environments can represent different facilities, different sections within the same facility, and so on. There can be more than one IIEM per environment.

As shown in the block diagram 400, IIEM 420 is configured to monitor industrial device 1 430, and industrial device 2 432. Any number of industrial devices can be associated with an IIEM. The IIEM can receive any number of uploading instructions from the cloud server. Each industrial device can be associated with a different uploading instruction, or uploading instructions can be shared between one or more industrial devices coupled to the ITEM. The uploading instructions can determine conditions, such as a schedule, an anomalous event, an electrical or environmental condition, and so on, under which the IIEM uploads information to the cloud server. A first uploading instruction within one or more uploading instructions can be associated with a first industrial device within the one or more industrial devices, and a second uploading instruction within the one or more uploading instructions can be associated with a second industrial device within the one or more industrial devices. The uploading instructions can specify an uploading frequency. An uploading frequency of the first uploading instruction can be different from an uploading frequency of the second uploading instruction. In disclosed implementations, the industrial devices may send data directly to the ITEM 420.

Embodiments include recording, by the IIEM, operational data associated with the one or more industrial devices, wherein the recording is based on a sampling frequency. The operational data that is collected can include electrical data 440, environmental data 442, etc. The electrical data can include voltage, current, transient waveforms, and so on. The environmental data can include data such as airflow, temperature, humidity, and so on. The uploading instructions can include an uploading frequency. The uploading can be based on the uploading frequency. The uploading instructions can define one or more situations of interest. A situation of interest can refer to an anomaly or event that may indicate a potential problem, future problem, unusual condition that warrants further investigation, and so on. The situation of interest can be related to power monitoring, frequent voltage fluctuations, current spikes, phase imbalance, harmonic distortions above a threshold, unexpected load drops, unusual neutral current behavior, a rapid temperature rise, humidity spikes, vibration amplitude above a threshold, and so on. Once the IIEM detects a situation of interest, it can upload information to the cloud server without having to wait for the next scheduled upload in the uploading frequency. Early identification of one or more situations of interest can be key to maintaining uptime of industrial equipment. When the IIEM detects that the collected data corresponds to a defined situation of interest, the HEM can send data to the cloud server, regardless of the uploading frequency. The cloud server can send a new set of uploading instructions at any time to any IIEM. The new uploading instructions can cause the IIEM to send data more or less frequently, define additional or different anomalous events, remove one or more anomalous events, direct the IIEM to perform local analysis, and so on.

The IIEM 420 can send operational data that was acquired to a machine learning model 470. In disclosed implementations, the machine learning model can be hosted on the IIEM. The language model can be a type of machine learning model that can be trained to understand, generate, and predict tokenized events, including human language. In disclosed implementations, the language model is trained using a distillation process based on a large language model that is trained on a wide variety of data, ranging from books and websites to technical manuals and sensor logs, and so on. The machine learning model 470 can include a distilled small language model that is configured and disposed to run on a standalone embedded computing device, such as an IIEM. In disclosed implementations, the machine learning model 470 can operate in an offline mode, in that no internet connection is required. Thus, in embodiments, the identifying and the reporting do not require communication to the cloud server. The language model can identify one or more anomalous events 472. As described above and throughout, an anomalous event can refer to a failure, a difference from normal operation, and so on in a piece of equipment. Anomalous events can be reported to a user, a floor manager, maintenance personnel, etc. to investigate whether a part failed or experienced a partial failure, to protect against a future failure, to investigate a non-normal operation, etc. The anomalous event can be associated with a signature within the operational data that was collected by the IIEM, a situation of interest, etc.

The signature, which can be an electrical signature, an environmental signature, and so on, can be correlated to an anomalous event by the LLM and applied to one or more pieces of equipment. Examples of anomalous events can include motor aging, increased mechanical resistance, equipment overheating, loss of efficiency, a different material being mixed within a mixer, an unplanned equipment shutdown, improper grounding issues, a broken drive belt on a motor, a worn-out bearing in a fan or pump, a motor speed controller failure, coil degradation and/or insulation breakdown, loose wiring and/or failing relays, and the like.

The language models used in disclosed implementations can assign probabilities to sequences of words (or tokens). In disclosed implementations, the language model can be based on neural networks that can include transformers and/or attention mechanisms to weigh the importance of different parts of a sentence and/or dataset. This can enable the handling of complex tasks such as summarizing industrial device information, classifying environmental data, and/or predicting potential failure events. Recall that the ML model can identify one or more anomalous events associated with an industrial device. Embodiments include performing an action 474 associated with the industrial device, wherein the performing is based on the identifying. Examples of performing an action can include shutting down a device, sending an alert, inspecting a device, displaying data, sending a message to programmable control logic (PLC), and so on.

In some embodiments, the performing is accomplished by an AI agent 476 associated with the industrial device. In disclosed implementations, the action can be performed automatically, partially automatically (with some human intervention), or in a fully manual mode. For example, in an automated mode, if the AI agent detects a sudden voltage spike indicative of an overheating motor, the AI agent may immediately trigger a cooling fan or reduce power to prevent damage. In a semi-automatic mode, the AI agent can send an alert to a human operator, who then decides whether to shut down the equipment or continue operation. In a fully manual mode, the AI agent can simply log the event and provide recommendations, leaving the final decision to the operator. Some of the actions that can be performed can include, but are not limited to, shutting down a device, sending an alert, inspecting a device, displaying data, and/or sending a message to a programmable logic controller.

Programmable logic controllers (PLCs) can play an important role in industrial automation and can seamlessly integrate with disclosed implementations to execute control actions based on detected anomalies. PLCs can use ladder logic, a graphical programming language designed to mimic electrical relay circuits, making it highly intuitive for industrial engineers. Ladder logic includes rungs, where each rung represents a control operation, such as turning on a motor or activating a safety alarm. When the AI agent 476 detects an anomalous event, the AI agent can send a command to the PLC, which then executes predefined ladder logic sequences. For instance, if a conveyor belt motor exhibits erratic current fluctuations, the AI agent can send a signal to the PLC, prompting it to slow down or stop the motor to prevent further damage. Additionally, PLCs can provide real-time feedback to the AI agent, allowing for adaptive control strategies. By combining AI-driven anomaly detection with PLC-based automation, disclosed implementations can enhance operational reliability, reduce downtime, and improve overall efficiency in industrial environments. In embodiments, the performing is accomplished by an AI agent associated with the industrial device. In embodiments, the action comprises shutting down the industrial device. In embodiments, the action comprises inspecting the industrial device.

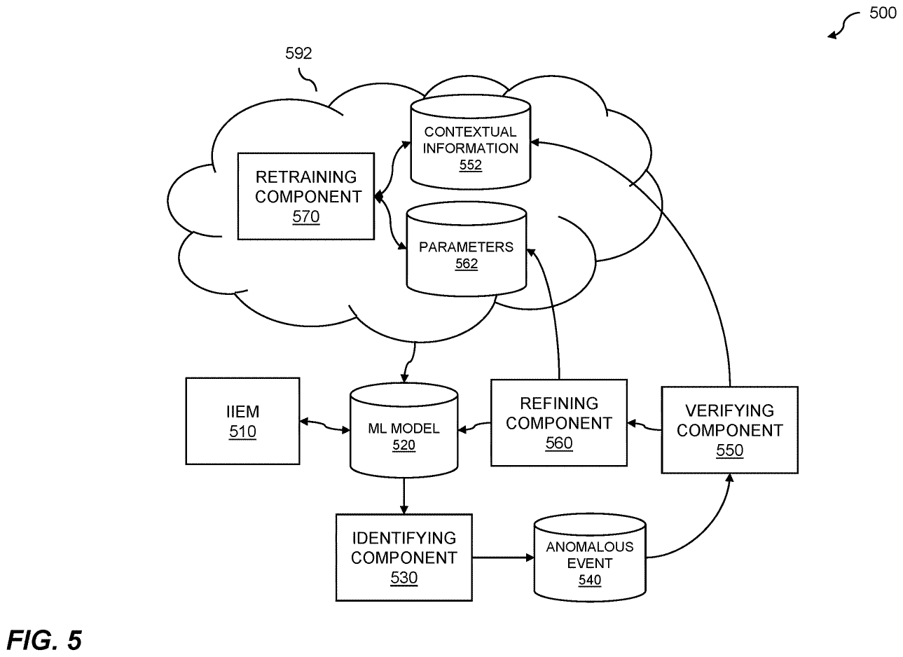

FIG. 5 is a block diagram for refining a local language model for an industrial IoT electrical monitor (IIEM). The block diagram 500 includes an IIEM 510. In disclosed implementations, the IIEM 510 can be configured to obtain electrical data and/or environmental data from one or more industrial devices, such as depicted in FIG. 3. The data from the IIEM provides data to a machine learning model 520. The machine learning model may be similar to the machine learning model 470 described previously. The machine learning model can be pushed to an ITEM in an industrial environment from cloud server 592.

The machine learning model can include an identifying component 530. The identifying component can include identifying, by the ML model, one or more anomalous events 540 associated with the industrial device, wherein the identifying is based on the operational data that was recorded and contextual information. Examples of anomalous events can include a belt breaking, a motor seizing, an overtemperature condition, a sudden loss of torque in a rotating shaft, an unexpected pressure drop in a hydraulic system, an irregular vibration pattern indicating possible misalignment, leakage currents above average operational thresholds, and so on. The anomalous events that are identified are provided to a verifying component 550. Embodiments include verifying, by a user, the one or more anomalous events. The verifying component can include functions and instructions to display information regarding a predicted anomalous event, such as a belt breaking. Additionally, the verifying component can be configured to receive human input as confirmation or rejection that the anomalous event actually happened.

In embodiments, the verifying includes inspecting the one or more industrial devices. For example, if the machine learning model 520 incorrectly predicted that a motor was failing due to a large current draw, but in actuality the large current draw was due to a heavier-than-typical object being placed on a conveyor belt, the verifying component can receive user input to indicate that situation. Similarly, if the system detects a sudden increase in temperature and flags it as an overheating issue, but an operator confirms that the factory had temporarily increased ambient heating for a special process, the verifying component can mark this as a false alarm. This feedback can help refine the model, reducing unnecessary alerts and improving predictive accuracy over time. In another scenario, the system might predict a lubrication failure in a gearbox based on an increase in frictional resistance, but an operator could verify that the machine had recently undergone maintenance, and the anomaly was caused by residual cleaning agents affecting sensor readings. By continuously incorporating human feedback, the system enhances its ability to distinguish between genuine failures and normal variations in industrial operations.

In some embodiments, the verifying includes updating the contextual information 552 with the one or more anomalous events that were verified. The output of the verifying component can be sent to the cloud to update contextual information that the ML model can use for further training of the ML model, training of another model, training of a larger model, and so on. The contextual information can include event signatures and corresponding anomalous events. In some embodiments, the updating includes associating the one or more anomalous events with the operational data that was recorded. The operational data can comprise one or more event signatures. By combining the event signatures with an anomalous event, the contextual information can help the ML to find new root causes of anomalous events in the future.

The output of the verifying component 550 can be input to refining component 560. Embodiments include refining the ML model, by the IEM, wherein the refining is based on the verifying. The refining can perform one or more refining techniques, such as transfer learning, hyperparameter tuning, and/or fine-tuning, in order to enhance the accuracy of the machine learning model. In embodiments, the refining is based on parameter-efficient tuning. In other embodiments, the refining is based on retrieval-augmented generation (RAG). In some embodiments, the language model comprises a small language model (SLM). In embodiments, the refining includes retraining the SLM. Since an SLM can be much smaller than an LLM, it can require far less compute power to retrain. Thus, the retraining of the SLM can be accomplished by the IIEM. The SLM can be another machine learning model that is able to be retrained on the edge with the IIEM. Data associated with the refining can be sent to the cloud server. One or more parameters 562 associated with the ML model can be updated within the cloud server. The parameters can be associated with any number of ML models.

Embodiments include rejecting, by the cloud server, the ML model that was refined. Because it can have access to more compute resources, the cloud server can determine that the refinements made by the IIEM are not the best way to optimize identifying anomalous conditions in the future. In this case, the cloud server can reject the refinements. The cloud server can accept the refinements, reject the refinements, retrain the model, etc. Embodiments include retraining 570 the ML model, by the cloud server. In further embodiments, the retraining is based on the refining.

In an industrial device context, the retraining of the model can include incorporation of false negative data. For example, in cases where an anomalous event occurred but was not detected by the machine learning model 520, the anomalous event along with electrical and/or environmental data associated with the event can be associated together as contextual information 552 that can be used in refining or retraining the machine learning model. For instance, if a motor bearing failure went undetected because the model was not trained on the specific frequency spectrum of the resulting vibration, the system can store the new vibration pattern and use it for future retraining. Similarly, if an overheating condition was missed because the ambient temperature was unusually high that day, the refining component can adjust the model to account for seasonal temperature variations. In another example, if a conveyor belt misalignment was not flagged because it developed gradually over time rather than as a sudden event, disclosed implementations can incorporate historical trend data into future anomaly detection processes. By continuously integrating missed events into the learning pipeline, the model can become more robust and adaptable to real-world industrial conditions.

In embodiments, the retraining 570 occurs on a schedule. A schedule can be an effective way to ensure the model is kept up to date with all relevant contextual information to make accurate inferences regarding anomalous events. The pushing can be based on the schedule as well. That is, when the model is retrained, it can be automatically pushed to the IIEM. Embodiments include sending, to the IIEM, the ML model that was retrained. In some embodiments, the retraining is in response to the one or more anomalous events that were identified. In some cases, an anomalous event may be missed that was significant, caused downtime of a tool, required longer maintenance times, etc. In these cases, it may be advantageous to immediately retrain the model so that such events can be caught by other IIEMs.

As described previously, the cloud server can train, refine, push, etc. any number of models. Each model can be tuned for a specific industrial device, family of devices, environment, and so on. The cloud server can also maintain, train, refine, use, etc. a larger model, such as an LLM. The LLM can perform inference in the cloud based on information sent by one or more IIEMs. Retaining of the LLM can be based on identifying, reporting, and verifying performed in similar manner to that described above. The LLM can be distilled into a smaller model that can be pushed to the ITEM 510 by the cloud server. In this way, the IIEM benefits from an updated model that maintains high accuracy while operating efficiently within the computational constraints of the HEM. By distilling a large model into a smaller version, the system reduces the memory and processing power required on the edge device, making real-time anomaly detection more feasible. Additionally, this approach minimizes the need for constant cloud communication, reducing network bandwidth usage and enabling continued operation even in environments with limited or intermittent internet connectivity. Furthermore, pushing an updated small model to the IIEMs can ensure that monitoring remains responsive to new failure patterns without requiring a complete overhaul of the local system, leading to improved adaptability and longevity of industrial equipment monitoring.

In disclosed implementations, a large language model may have hundreds of billions of parameters and be well suited for hosting on one or more cloud servers. A small language model may have fewer parameters and can also run on one or more servers. A SLM can be small enough for operation on an edge device, such as an IIEM. One or more implementations may utilize knowledge distillation techniques to train a small language model from a large language model. Thus, in disclosed implementations, a large language model can serve as a teacher model for a small language model that can be more easily trained, refined, and so on. The SLM can operate on an edge device, such as an IIEM or other locally-hosted computing device within an environment. As a non-limiting example, the teacher model can learn to recognize subtle signal changes, such as the precise current drop pattern that can indicate a broken belt, by analyzing historical data from many motors under various conditions. The distilled small language model can be deployed on an edge device near the equipment, such as an IIEM, continuously monitoring electrical signals in real time. If the IIEM detects an anomalous event, such as a spike suggesting increased viscosity in a mixer, the IIEM can immediately flag the issue and/or trigger an automated response, including automatic shutdown of equipment (such as the mixer, and/or a conveyor system feeding material into the mixer). This use of a small language model can reduce the need for constant cloud connectivity, minimize latency, and enable quicker responses while keeping hardware costs down.

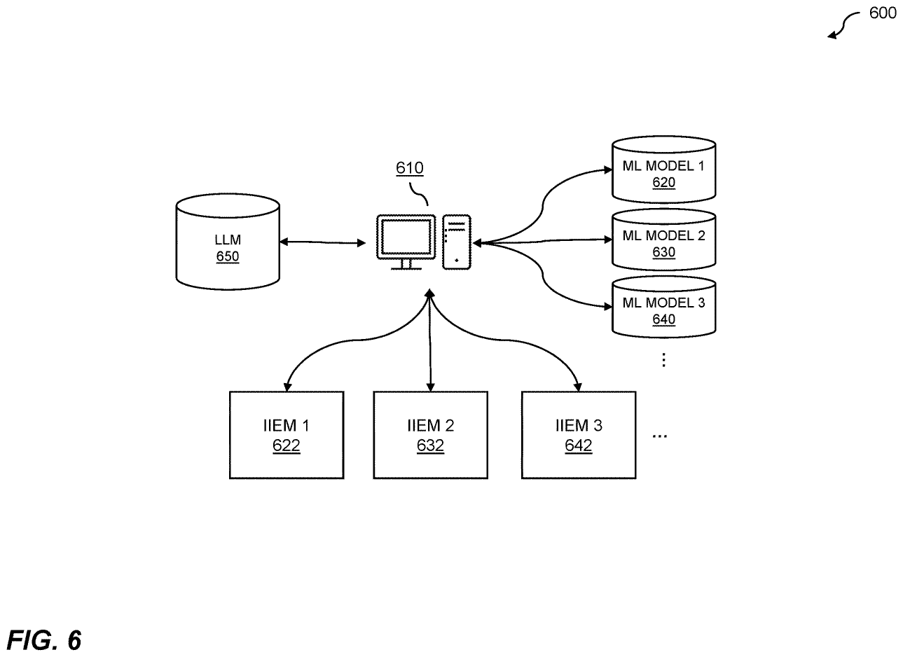

FIG. 6 is a block diagram for alternate machine learning models. The block diagram 600 includes a cloud server 610. The cloud server 610 can include virtual machines which allow multiple isolated environments to run on shared physical hardware, providing flexibility and scalability. Disclosed implementations can utilize containers, such as those managed by Docker®, to provide lightweight, portable environments for deploying applications efficiently across different computing infrastructures. Disclosed implementations can use bare metal servers to provide direct hardware access without a virtualization layer, which can be beneficial for performance-intensive tasks like training machine learning models. Disclosed implementations can include load balancing to ensure that incoming requests are evenly distributed across multiple cloud resources, preventing bottlenecks and improving reliability. In some implementations, orchestration tools such as Kubernetes® can be used to help manage and automate the deployment, scaling, and operation of containerized applications, ensuring that machine learning workloads are efficiently scheduled and resources are optimally utilized.

The cloud server 610 can train and/or refine a machine learning model such as a large language model (LLM) 650. The LLM can be trained on industrial device signatures, user manuals, technical manuals, diagnostic reports, and so on. Additional training sources can include real-time sensor data from industrial equipment, maintenance logs detailing past failures and/or repairs, historical operational patterns, and industry standards for predictive maintenance. Furthermore, the model can be fine-tuned using feedback from experienced technicians who validate predictions, ensuring that its recommendations align with real-world conditions.

The cloud server 610 can create one or more smaller models, indicated as ML model 1 620, ML model 2 630, and ML model 3 640. The ML models 620, 630, and 640 can be small language models or another machine learning model well suited for offline operation on edge devices such as IIEM 1 622, IIEM 2 632, and/or IIEM 3 642. In disclosed implementations, a large language model can be used to generate a smaller, specialized model by leveraging techniques such as knowledge distillation. This process involves training a compact model to mimic the predictions of the larger model while optimizing for lower computational requirements. By tailoring the smaller model to a specific set of tasks, such as analyzing power consumption anomalies and/or vibration irregularities in industrial machines, it can become highly efficient for real-time processing on edge devices. This can enable local inference without requiring constant communication with the cloud, ensuring that monitoring can continue even in remote locations or during network disruptions. The smaller ML models 620, 630, and 640 can be independent of LLM 650.

In some cases, a hybrid approach is used, in which one or more IIEMs send data to the cloud server 610 to be processed by the large language model. At other times, the ITEM may analyze operational data via local machine learning models, such as ML model 1 620, ML model 2 630, and/or ML model 3 640. The system can determine when to switch between cloud-based and local ML processing based on various criteria. If network congestion is detected, or if internet connectivity is lost, the system can automatically transition to using the local models to ensure uninterrupted monitoring. Conversely, when bandwidth availability improves, or if a particularly complex analysis is required, the system can offload computations to the cloud-based LLM for deeper insights. This adaptive approach can ensure that industrial monitoring remains resilient, providing redundancy in case of network issues while still leveraging the full power of cloud-based AI when feasible.

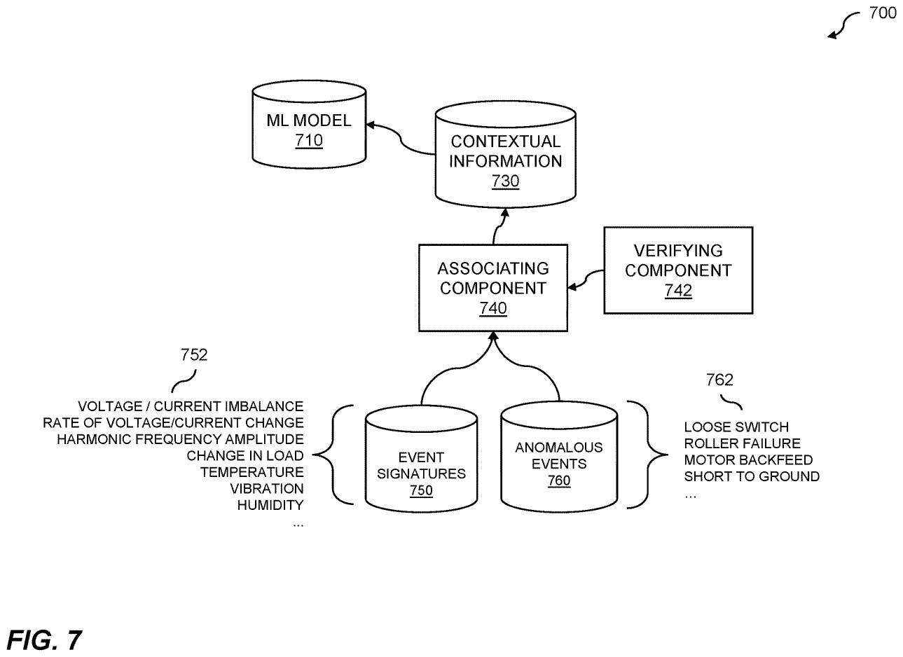

FIG. 7 is a block diagram for developing contextual information. The block diagram 700 can include a database of event signatures 750. The event signatures can include readings and/or trends for one or more parameters 752. The parameters 752 can include, but are not limited to, electrical parameters such as a voltage imbalance, current imbalance, rate of voltage change, rate of current change, harmonic frequency amplitude, and/or change in power load. The parameters 752 can include, but are not limited to, environmental parameters such as temperature, vibration, and/or humidity. The block diagram 700 further includes a database of anomalous events 760. The anomalous events 760 can include one or more failure modes 762. The failure modes 762 can include, but are not limited to, a loose switch, a roller failure, motor backfeed, a short to ground, and so on.

The event signatures 750 and anomalous events 760 are input to an associating component 740. The associating component 740 can create data that associates a signature with a given historical event. In disclosed implementations, the associating component 740 can create data in a comma separated value (CSV) format, a JSON format (such as described previously), an XML format, a YAML format, and/or other suitable data format. The data that is associated can be verified by a verifying component 742. The verifying component 742 can include user confirmation of anomalous events that occurred. The associated data serves as contextual information 730 that can be input to machine learning model 710 for training, validation, and/or inference.

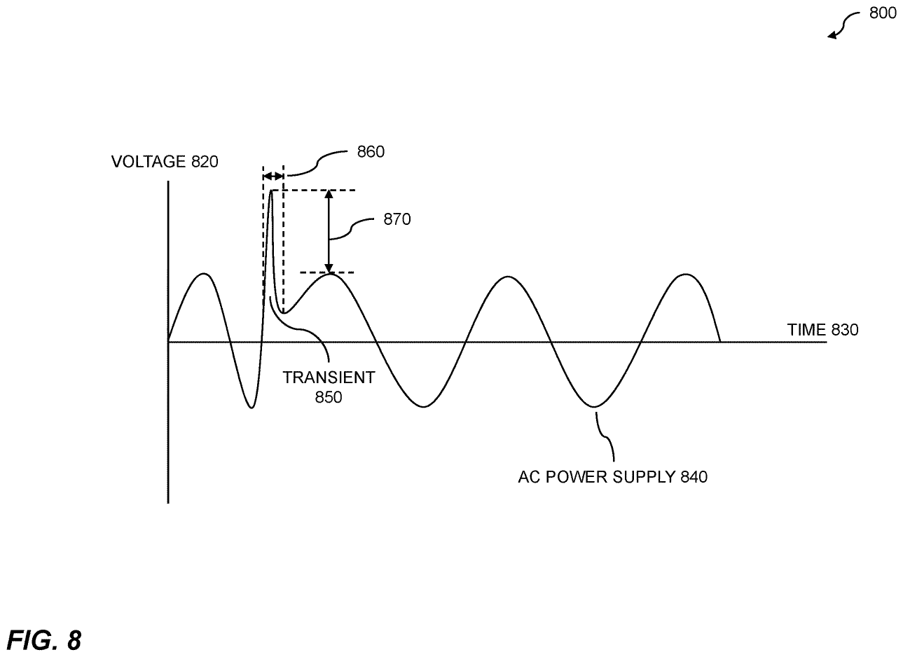

FIG. 8 is an example of a voltage transient. The example 800 includes a horizontal axis 830 representing time, and a vertical axis 820 representing voltage magnitude. Signal 840 represents a monitored alternating current voltage. A transient 850 has a peak amplitude above the normal maximum, indicated at 870, and a peak duration, indicated at 860. In disclosed implementations, if a transient exceeds a predetermined peak duration and/or peak amplitude above the normal maximum, then the transient can be treated as an anomalous event. The predetermined peak and/or duration can be defined heuristically from previous failures on similar equipment, via machine learning on a historical database, manually by a human, and so on. The cloud server can send updated uploading instructions to any IIEM with updated predetermined thresholds such as duration and peak magnitude. Thus, the cloud server can dynamically change the definition of an anomalous event. A similar principle can be applied to electrical current as well as voltage. The number of transients detected within a given time duration can be an anomalous event. Too many transients within a given time duration can be indicative of power grid instability, and/or other adverse conditions. The uploading instruction can include a threshold rate of transients, such as voltage or current transients.

Voltage spikes, current spikes, and/or other transient events on an AC power line can occur when there is a sudden, short-duration increase in voltage or current. These transients can often last from nanoseconds to milliseconds and can cause significant disruptions or damage to electrical systems. There are various contributors to transient events. Direct lightning strikes to power lines can cause massive voltage surges. Even indirect lighting strikes can induce electromagnetic pulses that can travel through power lines and damage equipment. Switching operations in the power grid can also cause transient events. For example, the energization or de-energization of long power lines can cause transient voltages due to the capacitance and inductance of the power grid. Moreover, the starting or stopping of industrial equipment such as motors, compressors, furnaces, and large transformers can cause sudden current draws or dumps, leading to voltage sags, spikes, harmonic distortions, etc. Short circuits and faults can cause sudden shifts in current, which can result in transients. Additionally, if a large facility or region suddenly disconnects from the power grid, the abrupt loss of load can create transient voltage fluctuations. Nonlinear loads (such as rectifiers, variable frequency drives, and power electronics) can introduce harmonics into the power grid. Furthermore, high-power RF sources, such as nearby radio transmitters or industrial RF equipment, can couple energy into power lines, introducing high-frequency transients. Regardless of the cause, these transients can damage sensitive electronics, reduce the lifespan of equipment, and cause operational disruptions. The real-time monitoring of disclosed implementations can help mitigate the impact of transients. In embodiments, the anomalous event comprises a peak magnitude of the transient waveform, wherein an absolute value of the peak magnitude exceeds a transient magnitude threshold. In embodiments, the anomalous event comprises a length of the transient waveform, wherein the length exceeds a transient length threshold. In disclosed implementations, the transient magnitude threshold and/or transient length threshold can be user-defined, and/or initialized to default values that can be adjusted later based on performance of the monitored industrial devices.

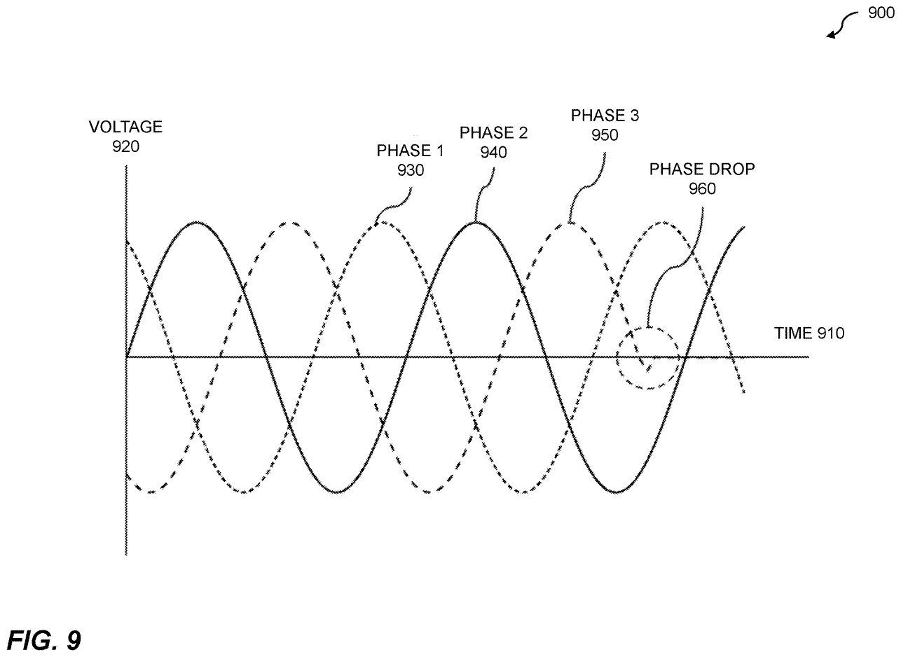

FIG. 9 is an example of a phase drop. The example 900 includes a horizontal axis 910 representing time, and a vertical axis 920 representing voltage magnitude. A first phase 930, second phase 940, and third phase 950 are shown. Three-phase power is a type of AC (alternating current) electrical power distribution that includes three sinusoidal voltage waveforms that are evenly spaced in phase. Three-phase power is the most common technique used for transmitting and distributing electrical power in industrial, commercial, and high-power applications, because it provides a more balanced and efficient power delivery compared to single-phase systems. In a balanced three-phase system, each voltage waveform has the same frequency and amplitude (e.g., peak voltage). Each phase is 120 degrees out of phase with the other phases. The frequency can typically range from 50 Hertz to 60 Hertz. In disclosed implementations, the three-phase power can be in a wye configuration or a delta configuration. Note that the vertical axis can be a current axis instead, without departing from the disclosed concepts.

A phase drop 960 that is associated with phase 3 is shown in example 900. A phase drop (also known as single-phase loss) in a three-phase power system occurs when one of the three voltage phases fails or experiences a significant drop while the other two remain active. This can result from various issues, including a blown fuse, a tripped breaker, loose or damaged wiring, transformer failure, or unbalanced loads that lead to excessive current draw in a single phase. In embodiments, the one or more industrial devices are powered by three-phase power. Many industrial machines, such as motors, compressors, pumps, CNC machines, robotic arms, and HVAC systems, rely on a stable and balanced three-phase power supply for optimal performance. A phase drop can lead to severe consequences, including overheating, motor damage, torque loss, and overall performance degradation.

Recall that an IIEM can determine whether the electrical data that was recorded represents an anomalous event related to the one or more industrial devices, wherein the determining is based on the one or more uploading instructions. In some embodiments, the determining includes detecting a phase drop, wherein the anomalous event comprises the phase drop. Industrial devices can be automatically shut down upon detecting a phase drop in their power supply to prevent potential damage. In the described implementations, a phase drop can be designated as an anomalous event, causing one or more IIEMs to send electrical data to the cloud server. In response, the cloud server and/or the IEM can warn a user, send an alert, shut down the equipment, and so on.

The detection of a phase drop can include performing a phase-to-neutral voltage check. The detection of a phase drop can include measuring the voltage of each phase relative to neutral (if available). A significant drop or loss in one phase indicates a phase drop. The detection of a phase drop can include performing a phase-to-phase voltage check. This can include comparing voltages between phases. A missing or significantly lower voltage between two phases can signal a phase failure. Some implementations can utilize phase angle monitoring to detect a phase drop. One or more implementations may utilize a phase loss relay to detect missing phases and trigger alerts and/or shutdowns of industrial equipment.

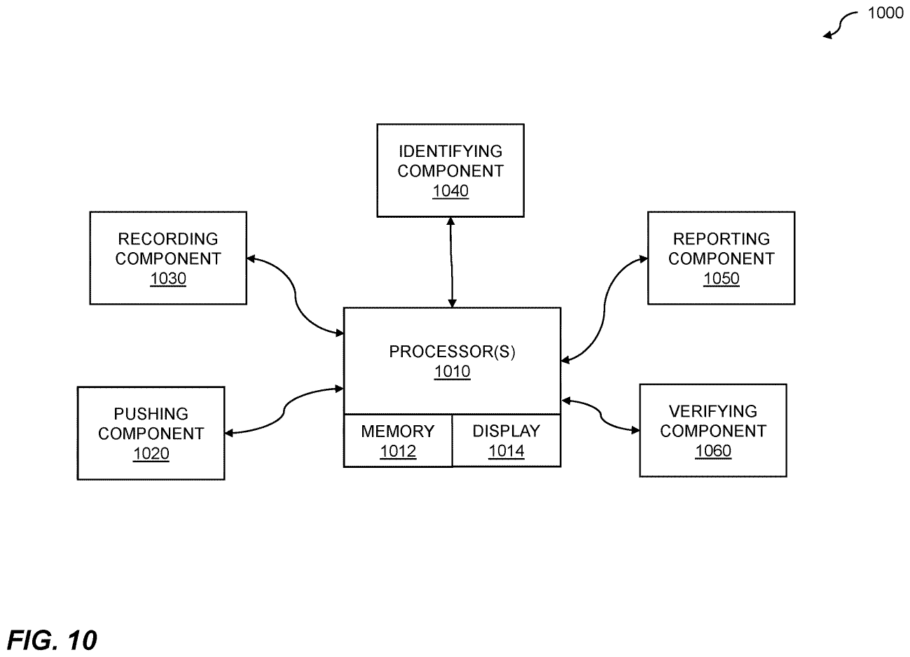

FIG. 10 is a system diagram for autonomous interpretation of electrical signatures with IoT-enabled monitors. The system 1000 can comprise a computer system for implementation of autonomous identification of electrical signatures with IoT-enabled monitors. The system can include one or more of processors, memories, cache memories, queues, displays, communication channels and networks, and so on. The system 1000 can include one or more processors 1010. The processors can include standalone processors within integrated circuits or chips, processor cores in FPGAs or ASICs, two or more processor cores within a multiprocessor, and the like. The one or more processors 1010 are coupled to a memory 1012, which can store instructions, operations, network traffic data, data requests, electrical data analysis, heuristics for industrial environments, routing information, language model training information, inference information from a language model, and so on. The memory can include one or more of local memory, shared cache memory, shared hierarchical cache memory, system memory such as shared system memory, etc. The system 1000 can further include a display 1014 coupled to the one or more processors. The display can be used for displaying data, instructions, operations, industrial equipment monitoring dashboards, etc. The operations can include routing operations, data transfer operations, and so on.

The system 1000 can include a pushing component 1020. The pushing component 1020 can include functions and instructions for pushing, by a cloud server, to an industrial IoT electrical monitor (IIEM), a machine learning (ML) model, wherein the IIEM is coupled to an industrial device within an industrial environment. As previously described, the cloud server can create, train, retrain, etc. a machine learning model, such as a small language model, and push that machine learning model to one or more edge devices in an industrial environment. To facilitate pushing of ML models, the ML model can be packaged in a standardized file format such as ONNX® (Open Neural Network Exchange) or TensorFlow Lite® (.tflite), ensuring compatibility with various edge devices. The cloud server can use secure transfer protocols such as HTTPS, MQTT, and/or SFTP to send the model to the HEM while maintaining data integrity and security. The deployment process can include cryptographic hash verification (e.g., SHA-256) to ensure that the model file has not been corrupted or tampered with during transmission. Once received, the edge device can automatically verify the integrity of the model using the checksum and then install it using a machine learning execution framework such as Ollama®, TensorFlow Lite®, or PyTorch Mobile®. An API can be provided on the edge device to handle model updates, including checking for new versions, downloading them securely, and validating compatibility before execution. Additionally, a rollback mechanism can be implemented to revert to a previous working model in case an update fails or causes unexpected behavior. In disclosed implementations, the pushing component 1020 can also support incremental updates to reduce bandwidth usage, sending only the portions of the model that have changed instead of re-transmitting the entire file. The incremental updates can enable more efficient and frequent updates, ensuring that edge devices remain optimized for accurate real-time monitoring without excessive downtime or network congestion.

The system 1000 can include a recording component 1030. The recording component 1030 can include functions and instructions for recording, by the HEM, operational data associated with the industrial device, wherein the recording is based on a sampling frequency. The operational data can include environmental data such as temperature, vibration, humidity, and so on. The operational data can include electrical data such as voltage data, current data, frequency data, phase data, data regarding transients, three-phase data, DC ripple data, and/or other relevant electrical data. The electrical data can be analyzed before it is sent to the cloud server. The analysis can be based on an FFT, STFT, wavelet transform, and so on. The sampling frequency can comprise 20 kHz, 40 kHz, 100 kHz, or any other suitable frequency. The electrical data can be uploaded to a cloud server. The IIEM can upload the operational data that was recorded to a cloud server. The uploading can be based on one or more uploading instructions. The uploading instructions can specify an uploading frequency, such as ten times per minute, or any other frequency. The uploading instructions can specify a situation of interest, such as a phase drop, a sudden temperature rise above a threshold, or another electrical or environmental condition. The uploading instructions can cause the IEM to send data to the cloud server regardless of the uploading frequency. In some implementations, the electrical data that is recorded can be processed/analyzed via a machine learning model executing locally (in the industrial environment).

The system 1000 can include an identifying component 1040. The identifying component 1040 can include functions and instructions for identifying, by the ML model, one or more anomalous events associated with the industrial device, wherein the identifying is based on the operational data that was recorded and contextual information. The language model can include a large language model, small language model, and/or other type of language model. In disclosed implementations, trained machine learning models can be used to identify patterns corresponding to an anomalous event.

The system 1000 can include a reporting component 1050. The reporting component 1050 can include functions and instructions for reporting, to a user, the one or more anomalous events that were identified. The reporting may be performed via a dashboard. The reporting schedule can be dynamic. The frequency of the reporting can change in response to identifying an anomalous event. The data that is uploaded can include data occurring both before and after an anomalous event is determined. As an example, in response to determining an anomalous event, 20 seconds of data prior to the anomalous event, along with 20 seconds of data following the anomalous event, can be uploaded to a cloud server for subsequent analysis. The uploading can include one or more portions of the electrical data surrounding the anomalous event. In embodiments, the uploading of instructions and/or reporting schedule can be based on a previous failure history of the one or more industrial devices. For example, industrial devices that have a history of frequent failure may be monitored and/or reported with a higher uploading frequency than industrial devices that do not have a history of frequent failure.

The system 1000 can include a verifying component 1060. The verifying component 1060 can include functions and instructions for verifying, by a user, the one or more anomalous events. The verifying can include confirming that an anomalous event occurred. The verification can be performed via a user interface. As an example, the system may present a timestamped alert to a maintenance technician via a tablet or workstation interface, indicating that the machine learning model has predicted a belt failure on a specific conveyor unit. The technician can visually inspect the equipment and confirm the failure with a single-click acknowledgment, optionally providing additional notes, such as root cause observations and/or environmental conditions. In disclosed implementations, the user interface can also support image and/or video upload, sensor log review, and/or voice notes to enrich the verification dataset.

The verifying component can support delayed confirmations, enabling operators to review alerts at the end of a shift. Verified events can be logged and used as part of a feedback loop to further train and refine the model, improving future predictive accuracy. Over time, this human-in-the-loop verification process can help reduce false positives, calibrate model thresholds, and build trust between operators and the industrial monitoring system. Additionally, the verifying component can track confirmation rates and cross-validate with other sensor data to detect systematic discrepancies, such as sensor drift and/or partial equipment degradation. This approach can strengthen the robustness of predictive maintenance frameworks and enable early intervention before catastrophic failure occurs, thereby reducing unplanned downtime, improving worker safety, and optimizing overall equipment effectiveness.

The system 1000 can include a computer program product embodied in a non-transitory computer readable medium for analysis, the computer program product comprising code which causes one or more processors to perform operations of: pushing, by a cloud server, to an industrial IoT electrical monitor (IIEM), a machine learning (ML) model, wherein the IIEM is coupled to an industrial device within an industrial environment; recording, by the IIEM, operational data associated with the industrial device, wherein the recording is based on a sampling frequency; identifying, by the ML model, one or more anomalous events associated with the industrial device, wherein the identifying is based on the operational data that was recorded and contextual information; reporting, by the IIEM, the one or more anomalous events that were identified; and verifying, by a user, the one or more anomalous events.

The system 1000 can include a computer system for analysis comprising: a memory which stores instructions; one or more processors attached to the memory, wherein the one or more processors, when executing the instructions which are stored, are configured to: push, by a cloud server, to an industrial IoT electrical monitor (IIEM), a machine learning (ML) model, wherein the IIEM is coupled to an industrial device within an industrial environment; record, by the IIEM, operational data associated with the industrial device, wherein the recording is based on a sampling frequency; identify, by the ML model, one or more anomalous events associated with the industrial device, wherein the identifying is based on the operational data that was recorded and contextual information; report, by the IIEM, the one or more anomalous events that were identified; and verify, by a user, the one or more anomalous events.

As can now be appreciated, disclosed implementations can provide industrial monitoring that is both decentralized and highly efficient by leveraging edge devices, such as Industrial IoT Electrical Monitors (IIEMs), to perform localized analytics using embedded machine learning models. These IIEMs can be implemented using compact, cost-effective single-board computers equipped with on-device inference capabilities, such as small, distilled language models. Since the models are executed locally, the IIEMs can operate in offline or intermittently connected environments, which is particularly valuable in remote industrial settings and/or secure facilities where consistent internet access may not be available or desirable. This decentralized architecture can conserve network bandwidth by eliminating the need to continuously transmit high-volume sensor data to a centralized cloud server, reducing latency for critical detections and lowering operational costs. Furthermore, by keeping sensitive telemetry data within the facility, disclosed implementations inherently support enhanced data privacy and compliance with industrial confidentiality requirements. The use of distilled models allows for fast inference on low-power hardware, enabling real-time monitoring of equipment for signs of anomalous behavior, such as overheating, motor stalling, belt breakage, and more. Over time, verified anomaly data collected locally can be securely synchronized with a central knowledge base for model updates, without sacrificing the benefits of edge-first intelligence. Altogether, these features can support robust, scalable industrial monitoring with enhanced resilience, privacy, and responsiveness.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for analysis comprising:
pushing, by a cloud server, to an industrial IoT electrical monitor (IIEM), a machine learning (ML) model, wherein the IIEM is coupled to an industrial device within an industrial environment;
recording, by the IIEM, operational data associated with the industrial device, wherein the recording is based on a sampling frequency;
identifying, by the ML model, one or more anomalous events associated with the industrial device, wherein the identifying is based on the operational data that was recorded and contextual information;
reporting, by the IIEM, the one or more anomalous events that were identified; and
verifying, by a user, the one or more anomalous events.

2. The method of claim 1 wherein the ML model is trained for inferences associated with the industrial device.

3. The method of claim 2 wherein the pushing, the recording, the identifying, the reporting, and the verifying include a second ML model and a second IIEM coupled to a second industrial device.

4. The method of claim 3 wherein the second ML model is trained for inferences associated with the second industrial device.

5. The method of claim 1 further comprising refining the ML model, by the IIEM, wherein the refining is based on the verifying.

6. The method of claim 5 further comprising rejecting, by the cloud server, the ML model that was refined.

7. The method of claim 5 further comprising retraining the ML model, by the cloud server.

8. The method of claim 7 wherein the retraining is based on the refining.

9. The method of claim 7 wherein the retraining occurs on a schedule.

10. The method of claim 7 wherein the retraining is in response to the one or more anomalous events that were identified.

11. The method of claim 10 further comprising sending, to the IIEM, the ML model that was retrained.

12. The method of claim 1 wherein the verifying includes inspecting the one or more industrial devices.

13. The method of claim 12 wherein the verifying includes updating the contextual information with the one or more anomalous events that were verified.

14. The method of claim 13 wherein the updating includes associating the one or more anomalous events with the operational data that was recorded.

15. The method of claim 1 wherein the identifying and the reporting do not require communication to the cloud server.

16. The method of claim 1 further comprising performing an action associated with the industrial device, wherein the performing is based on the identifying.

17. The method of claim 16 wherein the performing is accomplished by an AI agent associated with the industrial device.

18. The method of claim 17 wherein the action comprises shutting down the industrial device.

19. The method of claim 17 wherein the action comprises inspecting the industrial device.

20. The method of claim 17 further comprising modifying one or more operational parameters of the industrial device.

21. The method of claim 1 further comprising uploading data, by the IIEM, to the cloud server, wherein the uploading is based on an upload frequency.

22. The method of claim 1 wherein the identifying includes predicting, by the ML model, a future failure of the industrial device.

23. The method of claim 1 wherein the contextual information includes a plurality of verified historical events.

24. The method of claim 23 further comprising associating each verified historical event within the plurality of verified historical events with one or more event signatures.

25. A computer program product embodied in a non-transitory computer readable medium for analysis, the computer program product comprising code which causes one or more processors to perform operations of:
pushing, by a cloud server, to an industrial IoT electrical monitor (IIEM), a machine learning (ML) model, wherein the HEM is coupled to an industrial device within an industrial environment;
recording, by the IIEM, operational data associated with the industrial device, wherein the recording is based on a sampling frequency;
identifying, by the ML model, one or more anomalous events associated with the industrial device, wherein the identifying is based on the operational data that was recorded and contextual information;
reporting, by the IIEM, the one or more anomalous events that were identified; and
verifying, by a user, the one or more anomalous events.

26. A computer system for analysis comprising:
a memory which stores instructions;
one or more processors attached to the memory, wherein the one or more processors, when executing the instructions which are stored, are configured to:
push, by a cloud server, to an industrial IoT electrical monitor (IIEM), a machine learning (ML) model, wherein the HEM is coupled to an industrial device within an industrial environment;
record, by the IIEM, operational data associated with the industrial device, wherein the recording is based on a sampling frequency;
identify, by the ML model, one or more anomalous events associated with the industrial device, wherein the identifying is based on the operational data that was recorded and contextual information;
report, by the IIEM, the one or more anomalous events that were identified; and
verify, by a user, the one or more anomalous events.
